(19) United States
(12) Patent Application Publication
(10) Pub. No.: US 2025/0264866 A1
(43) Pub. Date: Aug. 21, 2025

(54) Batch Production Tracking System and Methods

(71) Applicant: DDS Company, Inc., Durham, NC (US)

(72) Inventors: Cornelis J. Janse Van Rensburg, Durham, NC (US); Tracie Jessie, Durham, NC (US); Richard Meaney, Chapel Hill, NC (US)

(73) Assignee: DDS Company, Inc., Durham, NC (US)

(21) Appl. No.: 19/053,952

(22) Filed: Feb. 14, 2025

Related U.S. Application Data
(60) Provisional application No. 63/554,365, filed on Feb. 16, 2024.

(51) Int. Cl. G05B 19/418

(52) U.S. Cl. CPC G05B 19/41865; G05B 2219/32128; G05B 2219/35488

(57) ABSTRACT

A batch production tracking system. The batch production tracking system may include one or more transmitters, wherein each one of the one or more transmitters may be associated with a carrier; and an arrangement of one or more sensors, wherein the arrangement of one or more sensors may be provided in relation to an arrangement of one or more workstations of a batch production workflow, and wherein the one or more sensors may be configured to sense a signal from the one or more transmitters and to determine a location of the associated carrier in the batch production workflow.

### RELATED APPLICATIONS

This application is related and claims priority to U.S. Provisional Patent Application Nos. 63/554,365, filed on Feb. 16, 2024; and 63/696,594, filed on Sep. 20, 2024, the applications of which are incorporate herein by reference in their entireties.

### TECHNICAL FIELD

The subject matter of the invention relates generally to workflow tracking systems and more particularly to a small batch production tracking system and methods including reliable case tracking.

### BACKGROUND

Batch production is a method of manufacturing in which the products are made as specified groups or amounts and within a certain time frame. A batch can go through a series of steps in a large manufacturing process to make the final desired product. Batch production is used for many types of manufacturing that may need smaller amounts of production at a time to ensure specific quality standards or changes in the process. This is opposed to large mass production or continuous production methods in which the product or process does not need to be checked or changed as frequently or periodically.

In the manufacturing batch production process, the machines are in chronological order directly related to the manufacturing process. In certain cases, batch production may require less expensive equipment, thus reducing the capital cost required to set up this type of system. One drawback of batch production is that smaller batches need a great deal of planning, scheduling, process control, and data collection. Further, it is not unusual for products to be lost during the batch production process due to poor methods of tracking. Therefore, new approaches are needed with respect to improving efficiency in small batch production processes.

### SUMMARY

In one embodiment, a batch production tracking system is provided. The batch production tracking system may include one or more transmitters, wherein each one of the one or more transmitters may be associated with a carrier; and an arrangement of one or more sensors, wherein the arrangement of one or more sensors may be provided in relation to an arrangement of one or more workstations of a batch production workflow, and wherein the one or more sensors may be configured to sense a signal from the one or more transmitters and to determine a location of the associated carrier in the batch production workflow. The one or more workstations each may include an interactive interface, wherein the interactive interface may be configured to allow a user to interact with and/or view an operation and/or status of one or more workstations and/or carriers. The interactive interface may include an interactive display device. The interactive display device may be configured to visually indicate a status of one or more of the carriers and/or the batch production workflow. The one or more workstations may be arranged in chronological order of steps of the batch production workflow of a product being processed. The one or more sensors may be configured to measure any one or more of acceleration, location, motion, proximity, light, orientation, force, angular velocity, magnetic field, pressure, altitude, humidity, and/or temperature. The one or more sensors may include short-range wireless low energy sensors. The arrangement of the one or more sensors may be configured such that sensing ranges of one or more of the one or more sensors overlap. Each one of the one or more transmitters may be physically coupled to a carrier. The system of claim 1, wherein each of the one or more transmitters may include a display. Each carrier used in a particular batch production workflow may be linked in the batch production tracking system via its associated transmitter with that specific batch production workflow. The status and/or case information related to the carrier in the batch production workflow may be automatically displayed on the interactive display device of its associated workstation upon the carrier with associated transmitter entering a sensor field of a sensor of the one or more sensors associated with that workstation. The one or more transmitters may include a smart tag. The smart tag may be configured to attach to the carrier. The smart tag may include a display.

In another embodiment, a carrier for use in a batch production tracking system is provided. The carrier may include a main body portion, including a front panel, a back panel, two side panels, and a floor panel; a top lip portion, wherein the top lip portion extends upward from a top edge of the two side panels and the back panel, and wherein the top lip portion forms a wall extending from a point on one of the two side panels to a point on the other of the two side panels, the wall not extending the full length of either of the two side panels; one or more stop features formed on an outer surface of the main body portion and/or the top lip portion; and a transmitter attachment point formed on the main body portion. The one or more stop features may include one or more upper stop features and one or more lower stop features formed on each of the two side panels. The upper stop features and the lower stop features may be configured such that when the product carrier is nested within another product carrier a bottom edge of the upper stop features rest atop an upper edge of the top lip portion of the other product carrier and a bottom edge of the lower stop features rest atop an upper edge of the side panels of the other product carrier. The transmitter attachment point may include a receiving mechanism configured to receive a transmitter and secure it thereto. The transmitter may be a smart tag. The transmitter attachment point may include track rails and a locking mechanism, wherein the track rails may be configured to receive an upper portion and a lower portion of the smart tag, and the locking mechanism may be configure to secure the smart tag in place once installed in the track rails.

In another embodiment, a method of using a batch production tracking system is provided. The method may include setting up a batch production workflow in a batch production tracking system for a product to be produced; assigning one or more transmitters to the batch production workflow for the product to be processed, and associating each of the one or more transmitters with a carrier; loading the carrier with items related to producing the product; initiating the batch production workflow; moving the carrier through a series of workstations of the batch production tracking system, wherein the batch production tracking system further comprises an arrangement of sensors associated with one or more of the workstations; and tracking the carrier through the batch production workflow, wherein when the carrier is in a sensing field of one or more of the sensors data from the transmitter associated with that carrier is sensed by the one or more sensors and communicated to an associated one or more workstations. Setting up a batch production workflow for a product to be produced may include inputting details of the batch production workflow into a workflow application of the batch production tracking system. The data from the transmitter may include information related to the status and/or location of the product carrier in the batch production workflow and/or status and/or operational data of the product being produced. The workstations may include an interactive display and some or all of the sensed data may be displayed thereon. Data sensed at one workstation may be communicated to one or more other workstations.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 and FIG. 2 illustrate block diagrams of an example of a batch production tracking system including reliable case tracking, in accordance with an embodiment of the invention;

FIG. 3 and FIG. 4 illustrate block diagrams of other examples of workstation configurations of the batch production tracking system shown in FIG. 1 and FIG. 2, in accordance with an embodiment of the invention;

FIG. 5 illustrates a perspective view of an example of an interaction display device of the batch production tracking system shown in FIG. 1 and FIG. 2, in accordance with an embodiment of the invention;

FIG. 6 illustrates a perspective view of an example of beacon hardware of the batch production tracking system shown in FIG. 1 and FIG. 2, in accordance with an embodiment of the invention;

FIG. 7 illustrates a block diagram of a batch production tracking system for tracking dental lab pans in a dental laboratory environment, which is an example of the batch production tracking system shown in FIG. 1 and FIG. 2, in accordance with an embodiment of the invention;

FIG. 8 illustrates a perspective view of an example of a dental lab pan of the batch production tracking system shown in FIG. 7, in accordance with an embodiment of the invention;

FIG. 9A through FIG. 11 illustrate screenshots of examples of various display views for operating the batch production tracking system shown in FIG. 7, in accordance with an embodiment of the invention;

FIG. 12 illustrates an example of a pan status display showing a sample snapshot from an example active batch production tracking system;

FIG. 13 illustrates an example pan status map on which the location of an example dental lab pan can be plotted.

FIG. 14 through FIG. 27 illustrate various views of another example of a dental lab pan of the batch production tracking system shown in FIG. 7, in accordance with an embodiment of the invention;

FIG. 28 through FIG. 29B illustrate various views of an example of a tag track of the dental lab pan shown in FIG. 14 through FIG. 27, in accordance with an embodiment of the invention;

FIG. 30A through FIG. 32B illustrate various views of an example of a smart tag of the dental lab pan shown in FIG. 14 through FIG. 27, in accordance with an embodiment of the invention; and

FIG. 33 through FIG. 46 illustrate various views of yet another example of a dental lab pan of the batch production tracking system shown in FIG. 7, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a small batch production tracking system and methods including reliable case tracking.

In some embodiments, the small batch production tracking system and methods may provide mechanisms for tracking the precise geographic location of a product moving through the system.

In some embodiments, the small batch production tracking system and methods may provide mechanisms that allow a user to determine the precise geographic location of a product moving through the system as well as workflow status and/or disposition.

In some embodiments, the small batch production tracking system and methods may provide any number and/or configurations of workstations and wherein the workstations may be arranged in chronological order directly related to the manufacturing process.

In some embodiments, the small batch production tracking system and methods may provide any number and/or configurations of workstations and wherein each of the workstations may include one or more interactive display devices.

In some embodiments, the small batch production tracking system and methods may provide any number and/or configurations of workstations and as well as any number and/or arrangements of sensing devices (e.g., Bluetooth low energy (BLE) beacon sensors) in close proximity to the workstations.

In some embodiments, the small batch production tracking system and methods may provide any number and/or configurations of workstations and as well as any number and/or arrangements of sensing devices (“receivers”) as well as product carriers equipped with certain hardware, e.g., beacon hardware, (“tags” or “transmitters”) and wherein bi-directional communication may exist between the sensing devices (“receivers”) and the beacon hardware (“tags” or “transmitters”) on the product carriers.

In some embodiments, the small batch production tracking system and methods may provide a workflow for administration users, another workflow for technician users, yet another workflow for shipping users, and still another workflow for manager users.

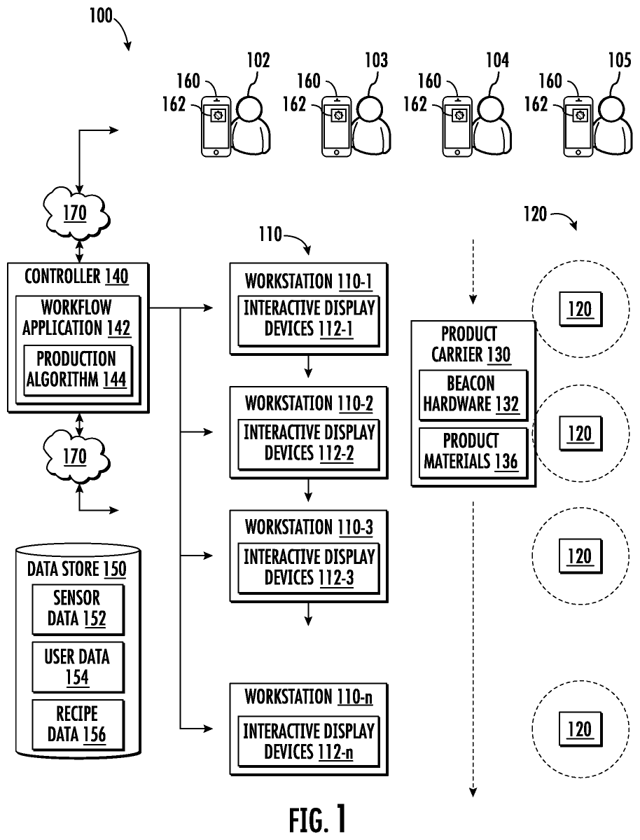

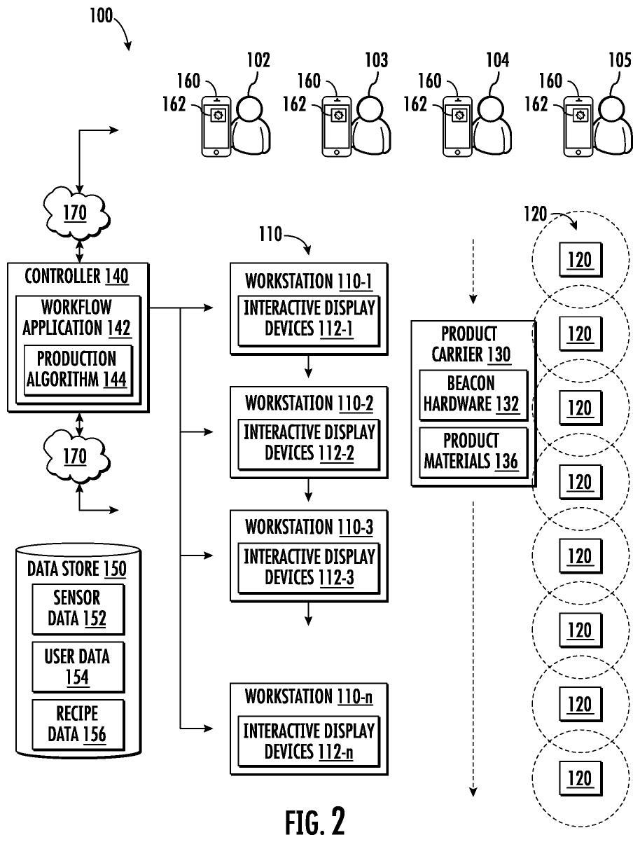

Referring now to FIG. 1 and FIG. 2 is block diagrams of one example of a batch production tracking system 100 including reliable case tracking, in accordance with an embodiment of the invention. Batch production tracking system 100 may provide mechanisms for tracking the precise geographic location of a product moving through a batch production system. Accordingly, batch production tracking system 100 allows a user to determine the precise geographic location of a product moving through the system as well as workflow status and/or disposition.

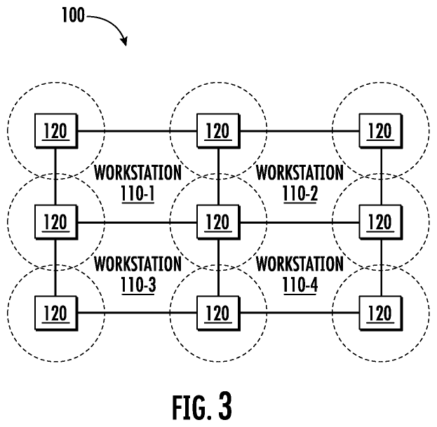

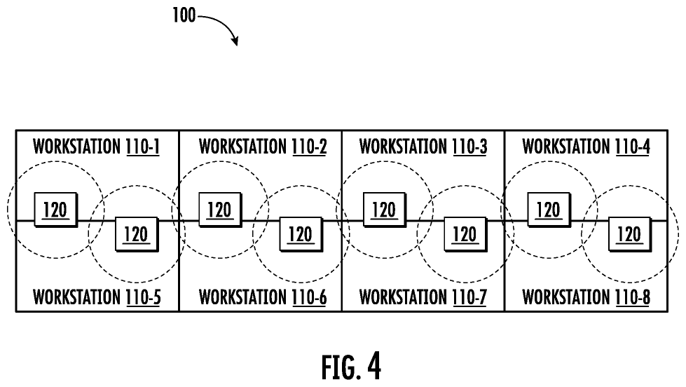

In this example, batch production tracking system 100 may include any number and/or configurations of workstations 110. Accordingly, batch production tracking system 100 may include workstations 110-1 through 110-n arranged in any configurations (e.g., see FIG. 3 and FIG. 4). Workstations 110-1 through 110-n may be any types of workstations for manufacturing any types of products in, for example, a small batch production process or environment. Further, workstations 110-1 through 110-n may be arranged in chronological order directly related to the manufacturing process. That is, the types of tasks performed at each of the workstations 110-1 through 110-n may be tailored to the specific product being manufactured and the specific chronological steps of manufacture.

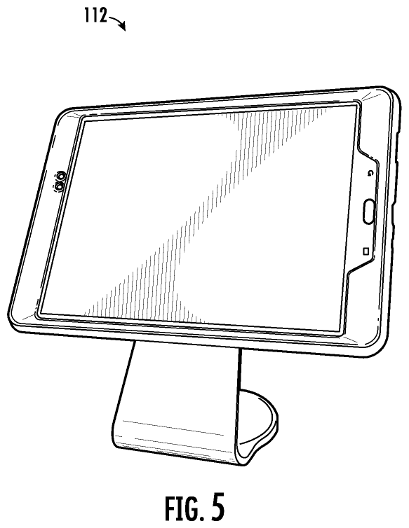

Each of the workstations 110 may include one or more interactive display devices 112. Interactive display devices 112 provide a means for users of batch production tracking system 100 to interact with the operation and/or status of its respective workstation 110. For example, workstation 110-1 may include one or more interactive display devices 112-1, workstation 110-2 may include one or more interactive display devices 112-2, and so on. In one example, each of the interactive display devices 112 may be a tablet device, such as, but not limited to, an Apple iPad or an Android-based tablet. An example of an interactive display device 112 is shown in FIG. 5.

Further, an arrangement of multiple sensing devices 120 may be provided in relation to the arrangement of workstations 110-1 through 110-n. Each of the sensing devices 120 may be, for example, a short-range wireless low energy sensor, such as a Bluetooth low energy (BLE) sensor (e.g., BLE beacon sensor). Generally, BLE beacon sensors are low-power devices for wireless detection and transmission, set up wirelessly and powered by internal batteries. BLE beacon sensors may be used to transmit sensor-related information to any other computing device. BLE beacon sensors may be capable of measuring various characteristics, such as, but not limited to, acceleration, motion, proximity, light, orientation, force, angular velocity, magnetic field, pressure, altitude, humidity, and/or temperature. Sensing devices 120 (e.g., BLE beacon sensors) are well-suited for efficiently tracking assets and collecting information within batch production tracking system 100.

In batch production tracking system 100, sensing devices 120 may be used to track, for example, a product carrier 130 that may be equipped with certain beacon hardware 132. In this example, beacon hardware 132 may be the transmitter and the sensing devices 120 may be the receivers. That is, sensing devices 120 may be used to detect a signal from beacon hardware 132 of product carrier 130.

Product carrier 130 may be loaded with product materials 136 for manufacturing and/or assembling a certain end product (not shown). Accordingly, product carrier 130 may be any device suitable for holding product materials 136. Product carrier 130 may be moved by any means from one workstation 110 to the next and wherein a certain unique process step is performed at each respective workstation 110. Accordingly, sensing devices 120 may be used as proximity sensors with respect to tracking the movement of product carrier 130 (via, for example, beacon hardware 132) from one workstation 110 to the next.

Further, bidirectional communication may exist between beacon hardware 132 and sensing devices 120. Additionally, beacon hardware 132 may emit a signal to be detected using sensing devices 120, and may also include an integrated accelerometer. Accordingly, sensing devices 120 may be used to collect both location data and motion data from beacon hardware 132 of product carrier 130.

Further, sensing devices 120 (i.e., the receivers) may be placed throughout the environment of workstations 110. Therefore, the more precise location identification is required, the more sensing devices 120 are required. This also depends on the ranges of sensing devices 120 and beacon hardware 132. In one example, FIG. 1 shows the placement of one sensing device 120 per workstation 110. In this example, there may be a gap between any two adjacent sensing devices 120. In another example, FIG. 2 shows the placement of multiple sensing devices 120 the arrangement of workstations 110 and providing overlapping sensing between any two adjacent sensing devices 120. In these examples, the arrangement of sensing devices 120 shown in FIG. 2 may provide more precise location identification than that shown in FIG. 1. Additionally, more details of other example configurations of workstations 110 and sensing devices 120 are shown below in FIG. 3 and FIG. 4.

Referring still to FIG. 1 and FIG. 2, batch production tracking system 100 may further include a controller 140 and a data store 150. In one example, controller 140 and data store 150 may be running on an application server (not shown). In another example, batch production tracking system 100 may support a cloud computing environment in which controller 140 and data store 150 may be running on a cloud-based server.

Controller 140 may be used for managing the overall operations of batch production tracking system 100. In one example, controller 140 may be a software application. In another example, controller 140 may be any controller, microcontroller, and/or microprocessor device that may provide processing capabilities, such as storing, interpreting, and/or executing software instructions. The software instructions may comprise machine readable code stored in non-transitory memory that is accessible by controller 140 for the execution of the instructions. Further, other data storage (not shown) may be built into controller 140.

Further, with respect to managing the operations of workstations 110-1 through 110-n, controller 140 may include a workflow application 142 that may further include a production algorithm 144. Workflow application 142 may be, for example, a manufacturing information system (MIS), manufacturing execution system (MES), or the like that has knowledge of the steps and locations for an item's production process.

Data store 150 may be, for example, data repositories (like databases) and/or flat files that can store data. Data store 150 may be volatile (such as random-access memory (RAM)), non-volatile (such as read-only memory (ROM), flash memory, etc.), or some combination of the two. Sensor data 152 may be stored in data store 150. Sensor data 152 may include, for example, any information provided by sensing devices 120 and/or beacon hardware 132. Sensing devices 120 and/or beacon hardware 132 may provide, for example, but not limited to, location data, acceleration data, motion data, proximity data, light data, orientation data, force data, angular velocity data, magnetic field data, pressure data, altitude data, humidity data, temperature data, and/or the like.

Various types of users may be associated with batch production tracking system 100. For example, administrative (admin) users 102, technician users 103, shipping users 104, and/or manager users 105 may be associated with batch production tracking system 100. Accordingly, user data 154 may be stored in data store 150. User data 154 may include, for example, any user account and/or user profile information associated with admin users 102, technician users 103, shipping users 104, and/or manager users 105.

In one example, admin users 102, technician users 103, shipping users 104, and/or manager users 105 may interact with batch production tracking system 100 via interactive display devices 112 at workstations 110. In another example, admin users 102, technician users 103, shipping users 104, and/or manager users 105 may interact with batch production tracking system 100 via any computing device, such as but not limited to, a mobile device 160 (e.g., a mobile phone (or smart phone), a tablet device, a smartwatch).

In one example, a workflow mobile app 162 may be installed and running on each of the mobile devices 160. Workflow mobile app 162 may be designed to operate on any device platform, including for example, Windows, Android, Apple, and/or the like known now or in the future. Accordingly, admin users 102, technician users 103, shipping users 104, and/or manager users 105 may interact with batch production tracking system 100, and in particular with workstations 110, using workflow mobile app 162. Interactive display devices 112 and/or workflow mobile app 162 may provide the user interface of batch production tracking system 100.

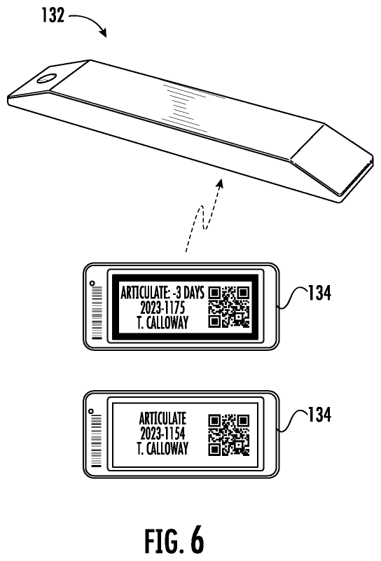

To support the use of mobile devices 160, batch production tracking system 100 may be provided in a networked computing configuration. For example, batch production tracking system 100 may be accessible via a network 170. Network 170 may be, for example, a local area network (LAN), a wide area network (WAN), and/or a cellular network for connecting to the Internet or to an Intranet. Further, in one example, controller 140 may be in communication with workstations 110 via a wired connection. In another example, controller 140 may be in communication with workstations 110 via network 170. Additionally, more details of a specific example of batch production tracking system 100 are shown and described below in FIG. 6 through 10.

Referring now to FIG. 3 and FIG. 4 is block diagrams of other examples of workstation configurations of batch production tracking system 100 shown in FIG. 1 and FIG. 2, in accordance with an embodiment of the invention. For example, FIG. 3 shows a 2×2 arrangement of four workstations 110 of batch production tracking system 100. That is, a 2×2 arrangement of workstation 110-1, workstation 110-2, workstation 110-3, and workstation 110-4. In this example, a sensing device 120 may be provided at each corner (including common corners) of the four workstations 110, for a total of nine sensing devices 120. In this example, the sensing ranges of some adjacent sensing devices 120 may overlap while the sensing ranges of other adjacent sensing devices 120 may not overlap.

FIG. 4 shows a 2×4 arrangement of eight workstations 110 of batch production tracking system 100. That is, a 2×4 arrangement of workstation 110-1, workstation 110-2, workstation 110-3, workstation 110-4, workstation 110-5, workstation 110-6, workstation 110-7, and workstation 110-8. In this example, a line of eight sensing devices 120 may be provided at about a center portion of the 2×4 arrangement of eight workstations 110. Further, in this example, the eight sensing devices 120 may be slightly offset or staggered in alternating fashion, as shown in FIG. 4. Further, in this example, the sensing ranges of adjacent sensing devices 120 may overlap.

Further, unique recipe data 156 may exist in data store 150 for each product moving through batch production tracking system 100 and wherein each product has a unique CaseID. For example, recipe data 156 for each product or CaseID may include the required product materials 136 to be provided within its associated product carrier 130. Further, recipe data 156 may include the required number and/or types of workstations 110 and the unique process steps that occur at each of the workstations 110.

Referring now to FIG. 5 is a perspective view of an example of interactive display device 112 of batch production tracking system 100 shown in FIG. 1 and FIG. 2, in accordance with an embodiment of the invention. Each of the interactive display devices 112 may be, for example, a tablet device, such as, but not limited to, an Apple iPad or an Android-based tablet. Accordingly, each of the interactive display devices 112 may have a touch screen. An interactive display device 112 may be used for both information display and system interaction.

Referring now to FIG. 6 is a perspective view of an example of beacon hardware 132 of batch production tracking system 100 shown in FIG. 1 and FIG. 2, in accordance with an embodiment of the invention. Again, beacon hardware 132 may be affixed to each product carrier 130. In one example, beacon hardware 132 may be small wireless beacon devices that incessantly transmit BLE signals (i.e., beacons) to, for example, sensing devices 120. Beacon hardware 132 may contain a radio, processor, and batteries, continuously transmitting an identifier to sensing devices 120 for accurate tracking of each of the product carriers 130 as they move from one workstation 110 to another within batch production tracking system 100.

Further, beacon hardware 132 may include an integrated accelerometer that allows production algorithm 144 of workflow application 142 to detect and “know” when a product carrier 130 is in motion-most likely being moved from one workstation 110 to another. Benefits of beacon hardware 132 including the integrated accelerometer may include, but are not limited to, the following.
1. On occasion when the system is “uncertain” where a product carrier 130 is located (perhaps it is equidistant between two sensing devices 120), the system can use both the “predicted” location based on recipe data 156 as well as the motion data to increase the confidence of the calculated location. That is, if the product carrier 130 is detected as having moved, but the accelerometer shows no motion, then perhaps product carrier 130 is just located on the sensory boundary between two sensing devices 120 and the system should show no change in its location.
2. A beacon that has been “not moving” but then “moves” a short distance into close proximity to the nearest sensing devices 120 is a candidate for “check-in/check-out” processing. This may allow the system to accurately track “in progress” CaseIDs and ultimately produce accurate “actual work time” in each step of the recipe.
3. As, for example, production algorithm 144 is optimized, the frequency that beacons of beacon hardware 132 transmit may be adjusted to potentially improve battery life. For example, when the product carrier 130 is not moving, the system can detect its location every few minutes. However, upon motion detection, it can be detected multiple times per second.

Referring still to FIG. 6, integrated into beacon hardware 132 that may be affixed to product carrier 130 may be, for example, a display 134, such as an e-ink display (black and white or multi-color). E-ink screens, such as those on e-readers like the Amazon Kindle, require much less power than LCD or LED screens such as those on mobile phones. However, in alternative embodiments LCD, LED, and/or other suitable screens may be used. In one non-limiting example, the size of display 134 may be about 2.9 inches diagonal and may be 296×128 (37,888) pixels.

Display 134 may be used to show minimal information due to its size and space limitations. For example, display 134 may be used to show a QR or barcode linking to the CaseID, the currently assigned or detected workstation 110 or technician user 103, current recipe step, due date, status (e.g., “Late”, “Rush”, etc.), and the like. For example, display 134 may be updated when the case is tagged as “late” to draw attention of the technician user 103 or other personnel. Display 134 may be used to provide a “smart label” for the product carrier 130. The “smart label” may be used as a “backup” display for critical information in the event that interactive display device 112 is not available to scan the ID of the product carrier 130.

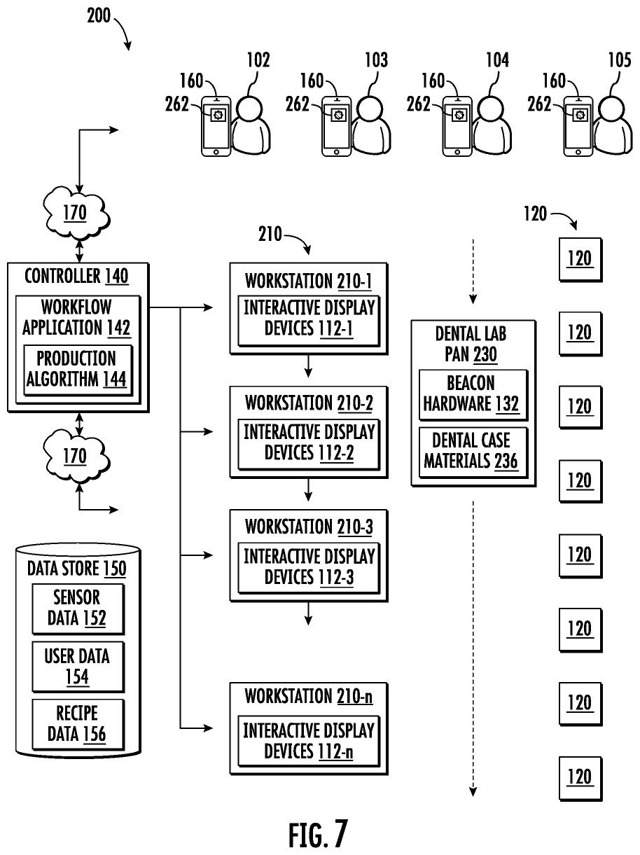

Referring now again to FIG. 1 through FIG. 6, features of batch production tracking system 100 may include, but are not limited to, the following.
1. Data visualizations that can be utilized by admin users 102, technician users 103, and/or manager users 105. The data visualizations may be provided using interactive display devices 112 of workstations 110 (see FIG. 5). Further, interactive display devices 112 may be used for indicating case status (e.g., on time or late). Examples of data visualizations are shown and described below in FIG. 7 through FIG. 11.
2. Beacon hardware 132 and sensing devices 120, and wherein the beacon hardware 132 may include other sensors, such as an embedded accelerometer, that may be used to help distinguish between, for example, a product carrier 130 “in motion” and “sitting on shelf.”
3. The ability to track simultaneously all of the product carriers 130 moving through batch production tracking system 100 at any given time.

Additionally, batch production tracking system 100 may provide mechanisms for the initial assignment of a Case to a product carrier 130. Further, batch production tracking system 100 may be used to facilitate “check-out” (or “clock-in”) and “check-in” (or “clock-out”) steps when a product carrier 130 is being actively worked on by a technician user 103.

Additionally, batch production tracking system 100 may provide mechanisms for determining product carriers 130 that are “late” according to the system of record. Then, using interactive display devices 112, may visually indicate the “late” status to both technician users 103 and manager users 105. Then, may remove the “late” indication if the product carriers 130 is no longer flagged as such by the system of record. Additionally, batch production tracking system 100 may provide mechanisms to correctly prioritize work items for technician users 103 in an automated way, eliminating guesswork and endpoint decision making by the technician users 103.

Further, in batch production tracking system 100, a certain workflow may be defined for admin users 102. Another workflow may be defined for technician users 103. Yet another workflow may be defined for shipping users 104. Still another workflow may be defined for manager users 105.

Referring now to FIG. 7 is a block diagram of an example batch production tracking system 200 for tracking, for example, dental lab pans in a dental laboratory environment, which is an example of the batch production tracking system 100 shown in FIG. 1 and FIG. 2, in accordance with an embodiment of the invention. In batch production tracking system 200, the product being manufactured may be, in non-limiting examples, dental prosthetics, implant retained hybrid products, dental surgical products, crown and bridge products, dentures, digital nightguards, implants, and/or any other small batch production type products.

Batch production tracking system 200 may be substantially the same as batch production tracking system 100 except that workstations 110 are replaced with workstations 210. Workstations 210 are any workstations, for example but not limited to, workstations tailored for producing dental products in a dental laboratory environment. Accordingly, in batch production tracking system 200, lab pan 230 is an example of product carrier 130 and dental case materials 236, e.g., dental case materials, is an example of product materials 136.

Further, in this example, batch production tracking system 200 may include a workflow mobile app 262 running on each of the mobile devices 160. Workflow mobile app 262 is specifically designed for tracking lab pans 230 in, for example, a dental laboratory environment.

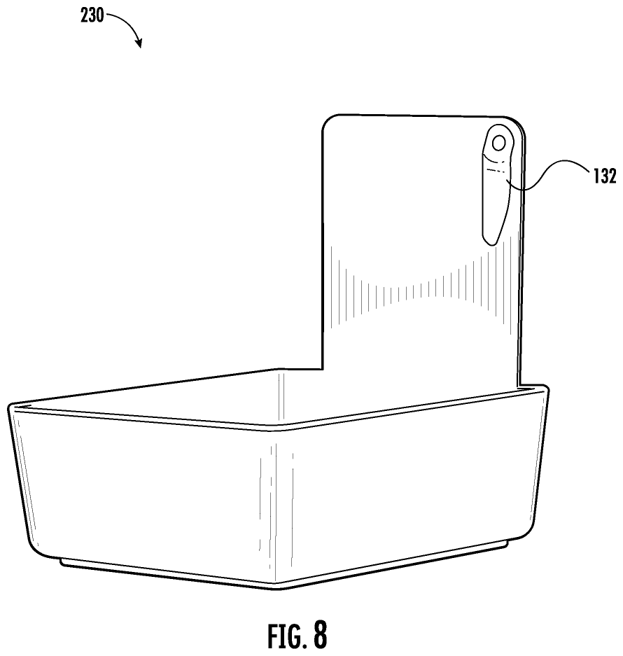

Referring now to FIG. 8 is a perspective view of an example of lab pan 230 of batch production tracking system 200 shown in FIG. 7, which is an example of product carrier 130. In this example, lab pan 230 may include the beacon hardware 132 shown in FIG. 6 that may also include display 134. Further, each lab pan 230 of batch production tracking system 200 may have a unique Pan ID. In one example, the Pan ID may be available as a label on the physical lab pan 230.

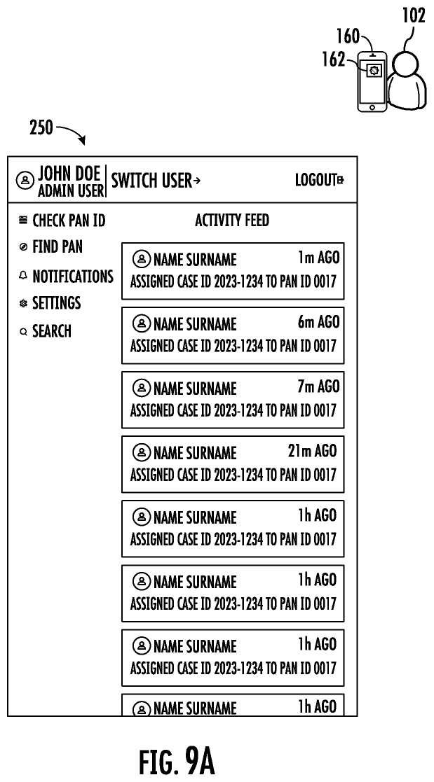

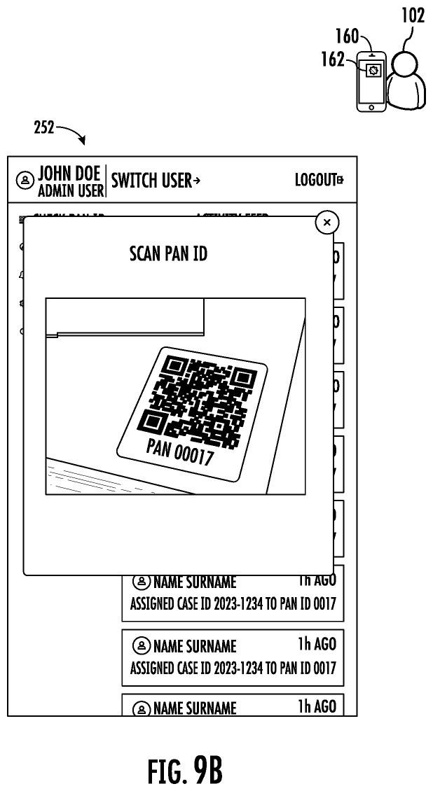

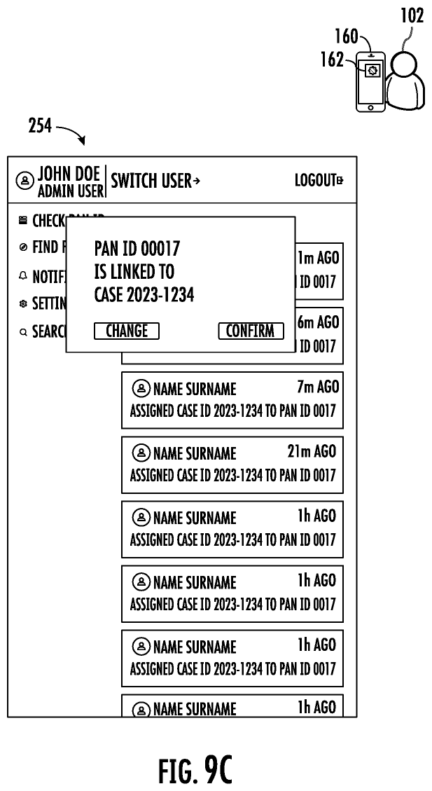

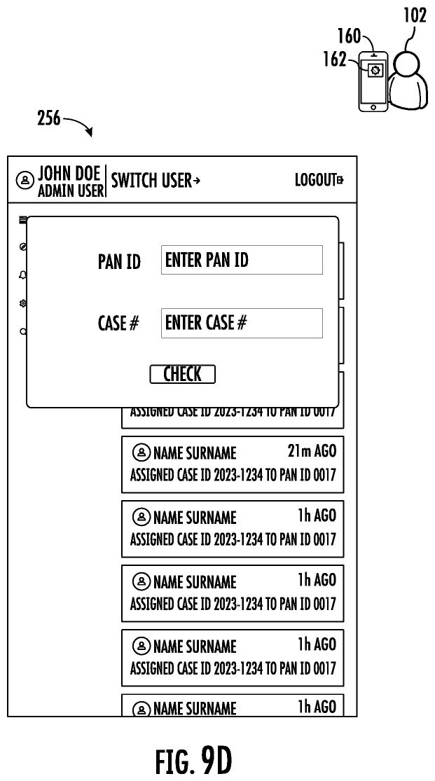

Referring now to FIG. 9A through FIG. 11 are screenshots of various example display views for operating the batch production tracking system 200 shown in FIG. 7, in accordance with an embodiment of the invention. Further, the display views shown in FIG. 9A through FIG. 11 may be displayed to the user via any one of the interactive display devices 112 and/or via workflow mobile app 262.

FIG. 9A, FIG. 9B, FIG. 9C, and FIG. 9D are screenshots showing an example workflow associated with admin users 102. For example, the goal for the admin user 102 is to start the tracking process of a Case (i.e., a particular patient case), as shown in display view 250 of FIG. 9A. This may involve putting the dental case materials 236 and associated information into a selected lab pan 230 and linking the Case Number to the Pan ID. Display view 252 of FIG. 9B shows an example of linking the Case Number to the Pan ID. Display view 254 of FIG. 9C shows an example of scanning the Pan ID. This relationship may be used by batch production tracking system 200 to report the location of the lab pan 230 during the manufacturing process. Batch production tracking system 200 must ensure the linkage of the Case Number to the Pan ID is correct. Display view 256 of FIG. 9D shows an example of the admin user 102 checking on the status of a certain Pan ID and Case Number.

Further to the example, a workflow associated with admin users 102 may include, but is not limited to, the following steps. The workflow may be facilitated using workflow application 142 at controller 140 and interactive display devices 112 at workstations 210.

At one step, an admin user 102 may enter the details of the Case into workflow application 142.

At a next step, the admin user 102 may enter the Pan ID assigned to this case (i.e., the Pan ID of the physical lab pan 230).

At a next step, the admin user 102 may save the case in workflow application 142, which establishes a case number (e.g., 2023-#####).

At a next step, the admin user 102 may add case details (e.g., scanned documents, such as, for example, Rx).

Using an interactive display device 112, an admin user 102 may log in using username/password, which may also set user type and location (e.g., Admin).

Next, the interactive display device 112 may display user information (such as, for example, Name and Role) to confirm successful login, as well as an activity feed appropriate to the Role.

Next, the admin user 102 may start the tracking process by selecting “Check Pan ID” using, for example, the touch screen of the interactive display device 112.

Next, a front camera of the interactive display device 112 may turn on and the resulting feed may be displayed on the device screen.

Next, the admin user 102 may scan the PanID (QR Code etched onto the beacon) using, for example, the camera of the interactive display device 112.

Next, upon successful scan, the linked Case Number may be displayed and the admin user 102 may be prompted to confirm that it is the correct (linked) Case Number and Pan ID.

Next, the admin user 102 may select (e.g., press) a “confirm” button to verify the relationship.

Next, if NOT matched, the admin user 102 may be able to CHANGE the linked Case Number by keying in the correct Case Number, and then may be asked to repeat the “Check” process.

Next, if an error occurs, the admin user 102 may be informed of the type of error and the required next action (such as repeating the scan process). An example of an error scenario may be a Pan ID that was not “released” from a previous Case Number.

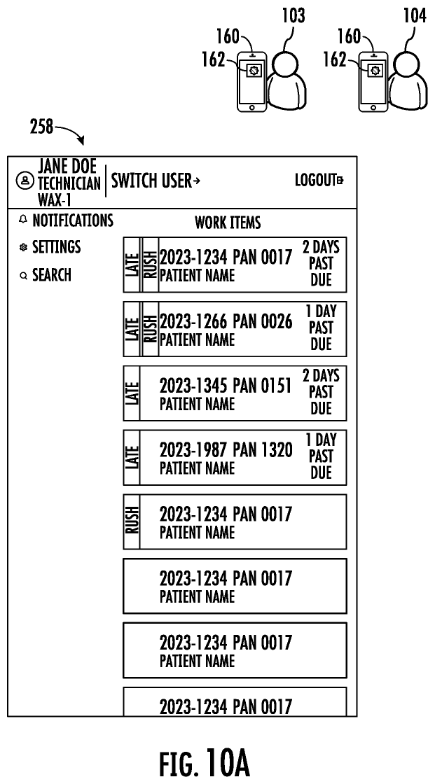

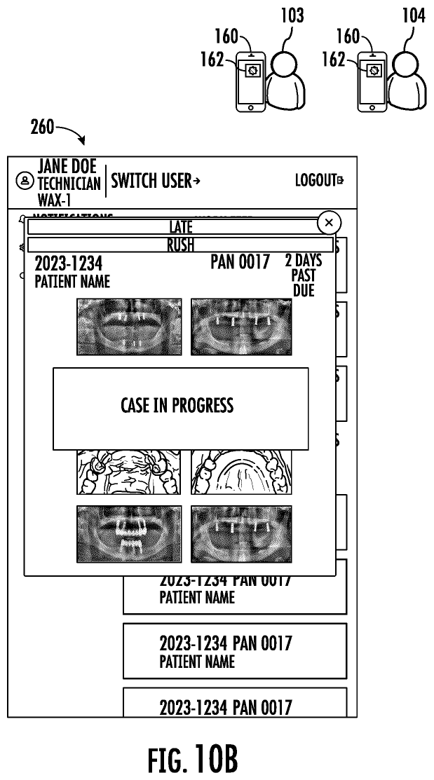

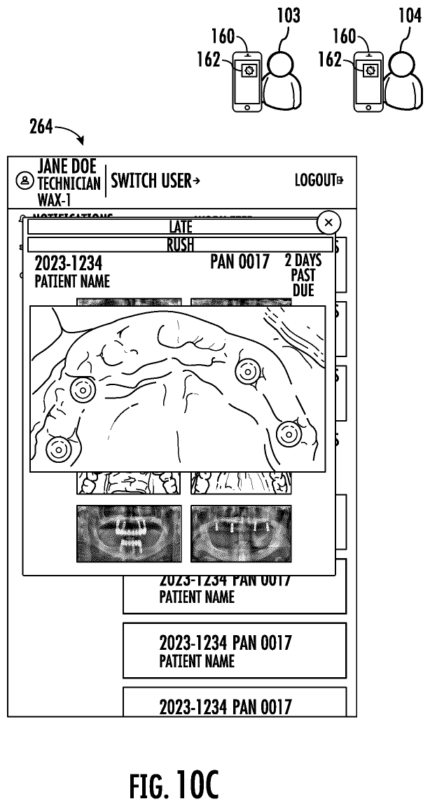

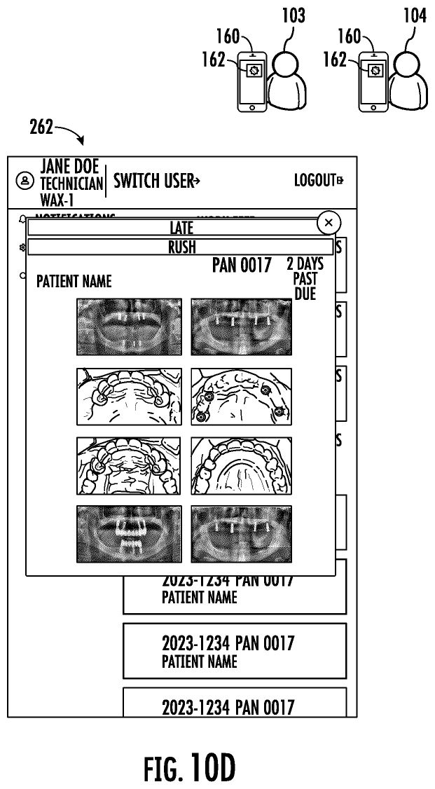

FIG. 10A, FIG. 10B, FIG. 10C, and FIG. 10D are screenshots showing an example workflow associated with technician users 103 and shipping users 104. To complete the case, a series of tasks must be performed. The technician user 103 may perform these tasks. When a lab pan 230 is moved very close to a sensing device 120, the lab pan 230 may be said to be “in-focus.” Bringing a lab pan 230 in-focus may be used to change the state of the lab pan 230. In one embodiment, a lab pan 230 may be defined to be in one of three states:
1. Pan Unassigned—A lab pan 230 is not assigned unless the lab pan 230 has been placed in-focus (in range of sensing device 120) at a given workstation 110. A lab pan 230 can be located at a workstation 110 but still not assigned, e.g., not in-focus.
2. Pan Assigned—A lab pan 230 may be assigned to a given workstation 110 when the lab pan 230 is brought in-focus (in range of sensing device 120) at the workstation 110.
3. Pan In-progress—A lab pan 230 may be said to be in-progress when a task is currently being performed on the pan's case by the technician user 103.

Display view 258 of FIG. 10A shows an example of the Pan IDs assigned to a certain technician user 103. Display view 260 of FIG. 10B shows an example of a case in progress. Display view 262 of FIG. 10C shows an example of Case images associated with a certain patient and Pan ID. Display view 264 of FIG. 10D shows an example of a magnified view of one specific Case image shown in display view 262 of FIG. 10C.

Further to the example, an example workflow associated with technician users 103 may include, but is not limited to, the following steps. The workflow may be facilitated using workflow application 142 at controller 140 and interactive display devices 112 at workstations 210. Again, the lab pan 230 may be defined to be in one of three states: Pan Unassigned, Pan Assigned, or Pan In-progress.

Using an interactive display device 112, the technician user 103 may log in using, for example, username/password, which may also set user type and location (Technician).

Next, the default view for a technician user 103 may be displayed at interactive display device 112. For example, the default view for a technician user 103 may include a Current Work Queue, prioritized as follows:
LATE RUSH, by number of days late
LATE, by number of days late
RUSH by days until due date
Other by days until due date

Next, by selecting a CASE (e.g., touching the “card” on the tablet screen), the technician user 103 may view case details, including Case images. Tapping a Case image may enlarge from “thumbnail” view to full-screen view or 100% of image size, depending on image resolution. “Pinch to zoom” may be enabled for image viewing.

Next, moving the physical lab pan 230 into close proximity to a sensing device 120 and holding it there for a period of time (e.g., approximately 1 second) toggles the lab pan 230 to “in-focus” state.

Next, if a lab pan 230 is Unassigned and becomes in-focus, it may be assigned to the technician user 103.

However, if a lab pan 230 is Assigned to another technician user 103 and becomes in-focus at a new location, it may be assigned to the new technician user 103. Further, if the lab pan 230 is also “In Progress”, it may be made no longer In Progress. This may be a “check-out” action.

However, if a lab pan 230 is Assigned to the current technician user 103 and becomes in-focus, it may be made “In Progress.” This may be a “check-in” action.

However, if a lab pan 230 is Assigned to the current technician user 103 and is also In Progress, it may be toggled to no longer In Progress. This may be a “check-out” action.

The shipping user 104 may provide a specialized role with the function of “releasing” the Pan ID (i.e., a given lab pan 230) so that it is free to be linked to a new Case ID. A workflow associated with shipping users 104 may include, but is not limited to, the following steps. The workflow may be facilitated using workflow application 142 at controller 140 and interactive display devices 112 at workstations 210.

Using an interactive display device 112, the shipping user 104 may log in using, for example, username/password, which may also set user type and location (Shipping).

Next, interactive display device 112 may display user information (such as Name and Role) to confirm successful login, as well as an activity feed appropriate to the Role.

Next, the shipping user 104 may start the process by, for example, tapping a “Release Pan” navigation item.

Next, the front camera of the interactive display device 112 may be activated (turned on) and the resulting feed may be displayed on the device screen.

Next, the shipping user 104 may scan the PanID (QR Code etched onto the beacon) using the camera of the interactive display device 112.

Next, upon successful scan, the linked Case Number may be displayed and the shipping user 104 may be prompted to confirm the desire to unlink and release the Pan.

Next, the shipping user 104 may activate (press) a “confirm” button to verify the action.

FIG. 11 is a screenshot showing an example of a workflow associated with manager users 105. Manager users 105 may have access rights and an interface similar to both admin users 102 and technician users 103. For example, the manager user 105 may be able to Find a Case using the system (based on location detected of the Pan ID), view Case Details, and/or potentially override some system data (e.g., the assigned technician user 103).

A workflow associated with manager users 105 may include, but is not limited to, the following steps. The workflow may be facilitated using workflow application 142 at controller 140 and interactive display devices 112 at workstations 210.

Using an interactive display device 112, the manager user 105 may log in using, for example, username/password, which may also set user type and location (Manager).

Next, the default view for a manager user 105 may be displayed at interactive display device 112. For example, the default view for a manager user 105 may include a Current Work Queue for all technician users 103, which may, for example, be prioritized as follows:
LATE RUSH, by number of days late
LATE, by number of days late
RUSH by days until due date
Other by days until due date

Additionally, the default view for the manager user 105 may include technician assignments (to assist with locating Cases), highlight Cases in the system that DO NOT match the expected location, and/or other information.

Referring now again to FIG. 7 through FIG. 11, batch production tracking system 200 may provide certain core functions, such as, but not limited to, the following:
“Switch User” function-simply logout/login;
Search/locate function-Search/locate a lab pan 230; and
Reports and notifications function;
“Smart Label” function; and
Beacon programming function.

Further, batch production tracking system 200 may provide certain manager functions, such as, but not limited to, the following:
Re-assign case/pans;
Multi-technician work queue monitoring; and
Multi-technician work queue monitoring.

Further, batch production tracking system 200 may provide certain technician functions, such as, but not limited to, the following:
“In-focus” function that enables “in progress” status toggle;
“In-focus” function for “check in/check out” status toggle;
Case details view; and
Work priority and logic view.

Further, batch production tracking system 200 may provide certain shipping functions, such as, but not limited to, the following:

### Release Pan ID

Further, the functions described above may be generally applied to batch production tracking system 100 shown and described in FIG. 1 through FIG. 6.

In summary and referring now to FIG. 1 through FIG. 11, batch production tracking system 100, 200 may receive an order from a customer for a given product. At time of order entry (input), each order may be assigned a “tag” (a transmitter, e.g., beacon hardware 132 with display 134) which may then be physically attached to the order. This information may be automatically communicated to workflow application 142 and/or production algorithm 144 of batch production tracking system 100, 200. This tag remains with the order until time of shipment (e.g., when the order leaves the manufacturing facility).

Throughout the batch production facility, sensing devices 120 (“receivers”) may be placed. The more precise location identification is required, the more sensing devices 120 may be required. In one example, for broad/general location, that is, location of order is in a given room or space, may require one sensing device 120 per room. In another example, for precise/exact location, that is, location of order is in a given room, on a specific side of the room, at a specific workspace/desk, etc., may require multiple sensors, potentially one or more for each workspace/desk.

Then, as the order flows/moves through batch production tracking system 100, 200 and the manufacturing process, the beacon hardware 132 (“tags” or “transmitters”) and sensing devices 120 (“receivers”) continuously communicate location of each individual order/tag.

This information may then be provided/available via a location report print out and/or a visual display map indicator which consist of a visual representation of the facility layout and the location of each order as it relates to the map using, for example, interactive display devices 112 and/or workflow mobile app 162, 262.

Workflow application 142 and/or production algorithm 144 may use the location identification of each order paired with production scheduling software to determine whether an order is in a wrong location and/or whether an order is behind schedule/late according to the production schedule of each given order.

Further, batch production tracking system 100, 200 may visually indicate on the printed report and/or display, amongst other things, the “location map”, and as well as on the “tag” itself, that a given order is in the wrong location, or behind schedule.

Further, batch production tracking system 100, 200 may provide the ability to use the beacon hardware 132 (“tags” or “transmitters”) and sensing devices 120 (“receivers”) to “log” a workspace and/or person in and/or out of a given task/step within the production scheduling software, allowing for instant date time stamp of when each scheduled task is started and/or completed and by whom. This allows for a historical track of each order.

Referring now again to FIG. 7 through FIG. 13, batch production tracking system 200 may be used for tracking lab pans 230 in a dental laboratory environment, according to the following example. Further, this method may be generally applied to the operation of batch production tracking system 100 described in FIG. 1 through FIG. 6.

There are two primary hardware components of batch production tracking system 200 that may be used for tracking lab pans 230. First, is the signaling device, which is beacon hardware 132. The second is the sensor, which is sensing device 120. In this example, beacon hardware 132 may be attached to the lab pan 230 and transmits beacons via Bluetooth Low Energy (BLE). There may be two different types of beacons transmitted by beacon hardware 132. For example, beacon hardware 132 may have an accelerometer that detects motion; when motion of the lab pan 230 is detected, beacon hardware 132 may transmit a specific set of beacons at about 500 millisecond intervals, or other suitable intervals. However, when it is detected that the lab pan 230 is stopped, then beacon hardware 132 may transmit a different set of beacons at about 5 second intervals, or other suitable intervals.

A sensing device 120 may be placed at each workstation 210 location to detect the presence of a lab pan 230. Sensing devices 120 may have a protocol to synchronize the time between all of the sensing devices 120. The beacons of each lab pan 230 may be detected by many sensing devices 120. All the sensing devices 120 report the beacons received at a configurable rate to a centralized server (e.g., controller 140 and data store 150 at an application server) on the same interval. For example, data collected by workflow application 142 and/or production algorithm 144 of controller 140 may include the unique ID of the beacon hardware 132 and the Received Signal Strength Indicator (RSSI). The RSSI values may typically be in a range from about −20 dBm to about −100 dBm, or other suitable range. Note: a −20 dBm may be considered a very strong signal and a −100 dBm may be considered a very weak signal. Controller 140 may take a snapshot that collects all the values reported for the beacon hardware 132 of any given lab pan 230 from all of the reporting sensing devices 120. This may be done for each of the lab pans 230 being tracked. For example, if 100 lab pans 230 are being tracked, there will be 100 snapshots processed at controller 140. These snapshots may currently be taken every one minute unless there is pan movement. If the lab pan 230 is in motion, a motion snapshot is taken within a second.

Once controller 140 has a given snapshot for a pan's beacons, workflow application 142 and/or production algorithm 144 may be used to analyze the data received from all sensing devices 120 and determine the location of a given lab pan 230. For the distance calculation, the following formula is used to calculate the distance in meters:

$$Distance = {10}^{( Measured Power - Instant RSSI ) / ( 10 \times N )}$$

“Measured Power” is the measured RSSI value when the beacon is exactly a defined distance (e.g., 1 meter) from the sensor. This gives a baseline measurement.

“Instant RSSI” is the measured value reported by the sensor in a snapshot.

“Variable (N)” is called the Loss Path Gradient and ranges between a defined range (e.g., 2 and 4). In ideal conditions with no obstructions the Gradient may be low (e.g., close to 2). In an area with lots of walls, people, or other obstructions, the Gradient may be larger.

The Loss Path Gradient is calculated by using the following formula:

$$N = ( Measured RSSI - Instant RSSI ) / ( 10. * log ( Instant Distance / Measured Distance ) )$$

In our example pan tracking case, controller 140 will default to using a Gradient value of N (e.g., N=3). Lab pans 230 that are located in different rooms may be reported at a greater distance than what is actual. This may be because the walls may cause the gradient to be a higher value. For example, production algorithm 144 may be programmed to classify these sensing devices 120 as more distant and may ignore selected results when determining the location of the lab pan 230.

When a lab pan 230 is placed very close to the sensing device 120 and the RSSI improves to a level of, for example, −35 dBm or better (less negative), the lab pan 230 may be classified as “in-focus”. When a lab pan 230 is “in-focus” at a location, the controller 140 is near 100% certain of the location and special actions can be taken for this lab pan 230. For example, it could mean this lab pan 230 is being “checked-in” to this location. Depending on the function performed at this location the “in-focus” state could trigger different actions in batch production tracking system 200.

### Example

To calculate the distance of an “in-focus” lab pan 230:

$$Measure Power = ( - 53 ) dB m , N = 3 ( noisy environment ) , Instant RSSI = ( - 35 )$$

$$Distance = {10}^{( - 53 ) - ( - 35 ) ) / 30} = {10}^{( - 0.6 )} or Distance = 0.25 meters ( \text{.25} meters is 9.8 inches )$$

In our example case, this shows the lab pan 230 as being “in focus” at about 10 inches of distance from the sensing device 120. Because the Gradient condition may vary between sensing devices 120, the “in-focus” level will be configurable per sensing device 120. For example, if the sensing device 120 is mounted below a table or work surface, a lower RSSI (e.g., worse than −35 dBm) might be seen when the lab pan 230 is at, for example, 10 inches, which means the “in focus” threshold will need to be lower (for example, −40 dBm) than an unobstructed sensing device 120.

It should be noted the RSSI signals vary for many different reasons. To help ensure accuracy within batch production tracking system 200, a moving average is maintained by the sensing device 120 to smooth out false and high variance data from the beacon hardware 132. Also, batch production tracking system 200 takes advantage of the integrated accelerometer to “lock” the lab pan 230 at a given location if no movement is detected.

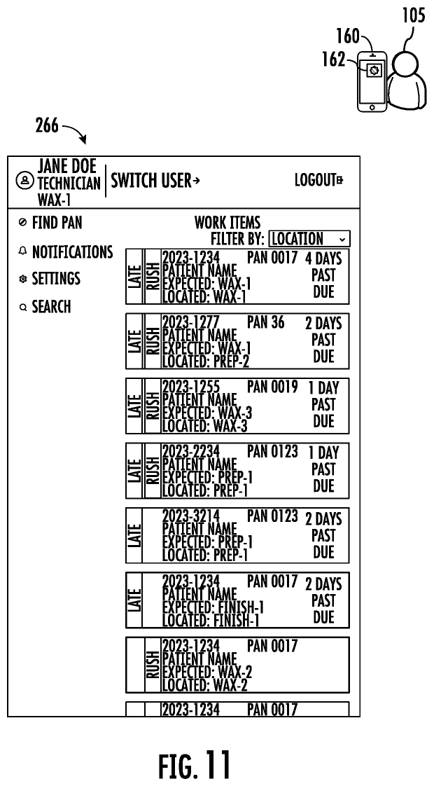

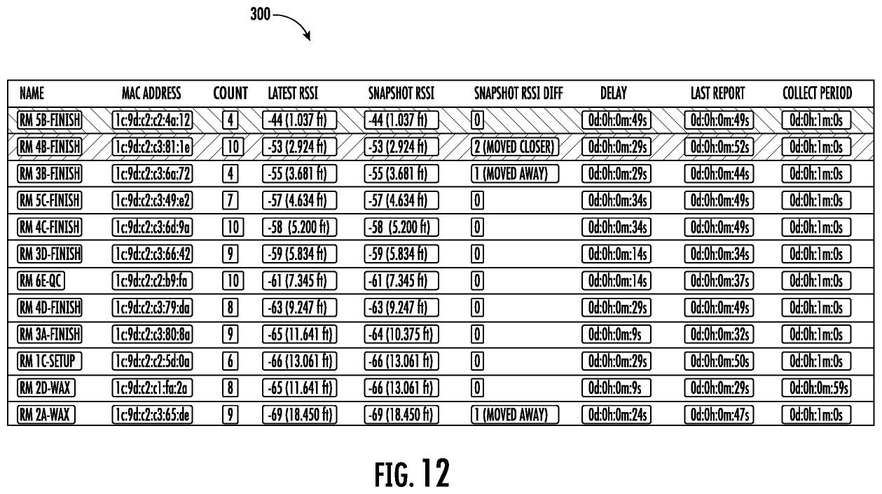

Referring now to FIG. 12 is an example of an example pan status display 300 showing an example sample snapshot from an active batch production tracking system 200. Pan status display 300 shows the location of one example lab pan 230 in an example batch production tracking system 200. This lab pan 230 is showing the nearest location of “RM 5B-Finish.”

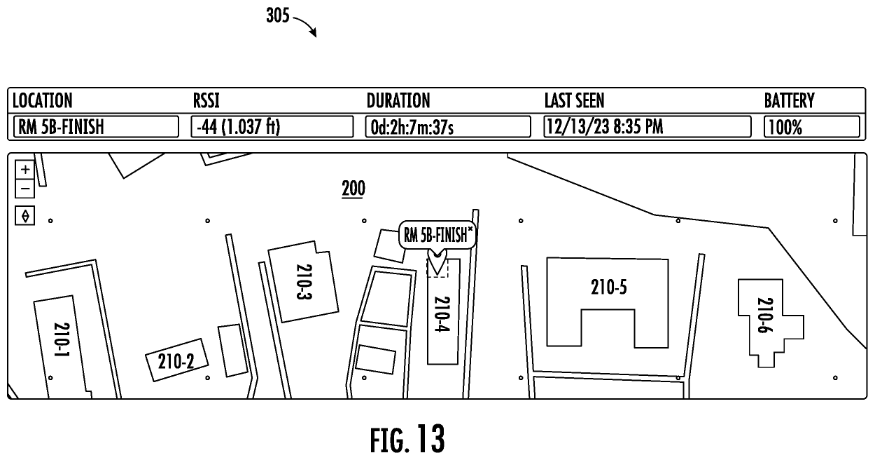

Because, for example, production algorithm 144 of controller 140 knows the latitude and longitude of the sensing device 120, e.g., “RM 5B-Finish,” the physical location of the lab pan 230 can be plotted on a map of, for example, a production facility, such as, a dental lab. For example, FIG. 13 shows an example of a pan status map 305 on which the location of the lab pan 230 can be plotted. Further, all data collected in this method of tracking lab pans 230 using batch production tracking system 200 may be stored in sensor data 152 at data store 150.

In one example, sensing devices 120 may be positioned to be about four (4) or more feet apart to help with the proximity locating of the lab pans 230 and to avoid proximity issues in reading the beacon hardware 132 sensor.

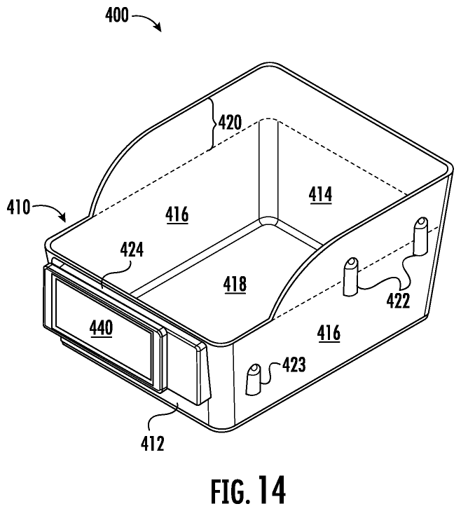

Referring now to FIG. 14 through FIG. 27 is various views of a lab pan 400, which is another example of the lab pan 230 of the batch production tracking system 200 shown in FIG. 7, in accordance with an embodiment of the invention.

FIG. 14 shows a perspective view of the lab pan 400. In this example, lab pan 400 may include a main body 410, and may include a top lip portion 420 on the upper edge of the main body 410. The main body 410 may include a front panel 412, a back panel 414, two side panels 416, and a floor panel 418, all arranged as shown in FIG. 14.

The top lip portion 420 may provide additional vertical space. In one non-limiting example, top lip portion 420 may provide about an additional 32 millimeters (mm) of vertical space. Unlike most traditional lab pans, this additional vertical and horizontal enclosure further protects and prevents small or fragile items from becoming damaged or falling out of the pan as they are transported between locations.

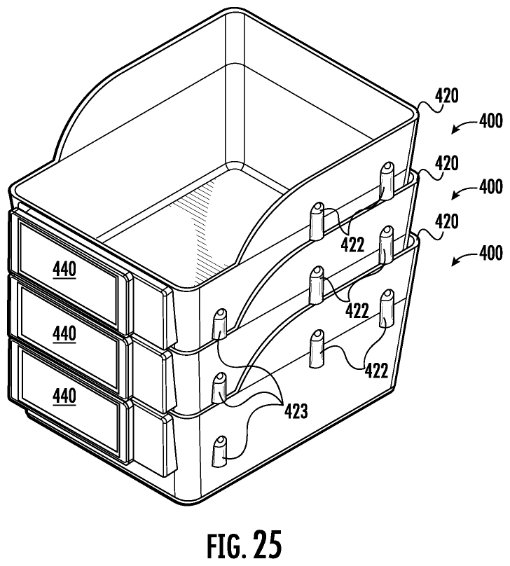

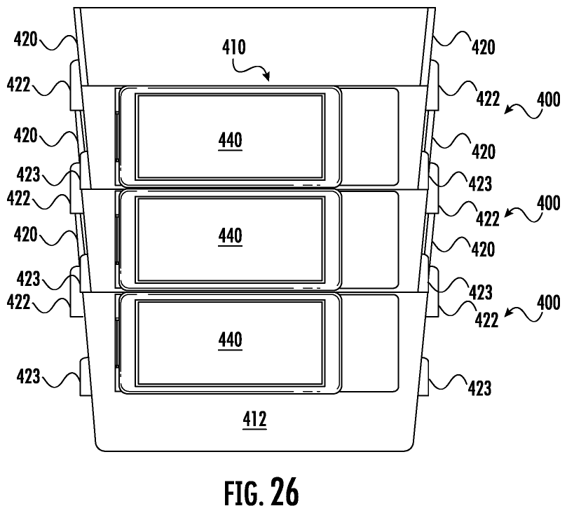

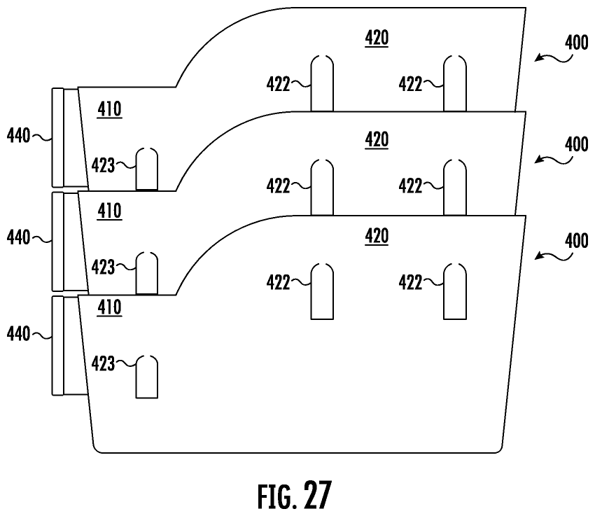

Arranged on the outside of each side of the lab pan 400 may be upper stop features 422 and may further include one or more lower stop features 423. In one example, there may be two upper stop features 422 and one stop feature 423 on each side. The stop features are used for facilitating stacking multiple lab pans 400, as shown, for example, in FIG. 25, FIG. 26, and FIG. 27. Additionally, a tag track 424 is provided on the outside of, for example, the front panel 412 of the lab pan 400. The tag track 424 may be used for receiving and holding a smart tag 440. Generally, the lab pan 400 may be formed of any rigid, lightweight, durable, and cleanable material, such as, but not limited to, molded plastic, aluminum, and/or the like.

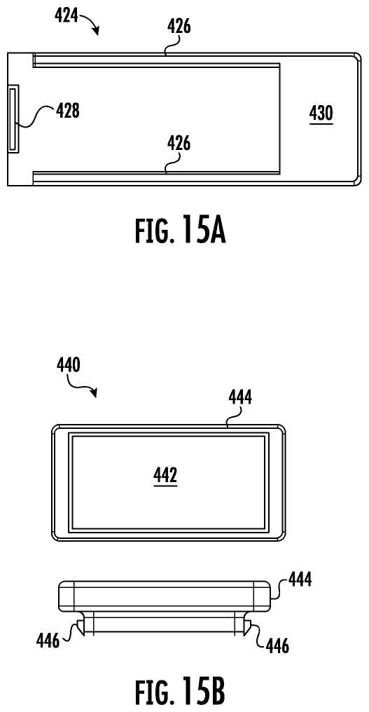

FIG. 15A shows an example of more details of the tag track 424. In this example, the tag track 424 may include a pair of track rails 426, a tag lock bar 428, and a track label area 430, all arranged in one example as shown. The tag track 424 is sized to substantially correspond to the size of the smart tag 440. FIG. 15B shows an example of more details of the smart tag 440. In this example, the smart tag 440 may include a tag display 442, a display frame 444, and a tag grip portion 446 for fitting into the track rails 426 of the tag track 424. Yet more details of the tag track 424 and the smart tag 440 are shown and described below in FIG. 28 through FIG. 32B.

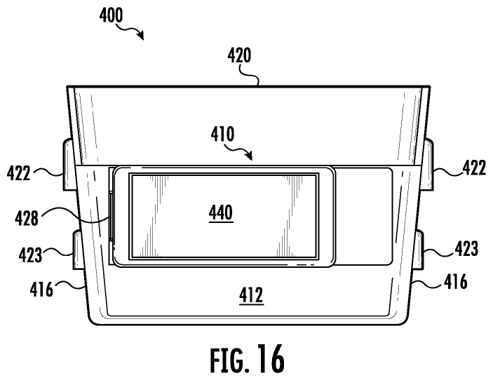

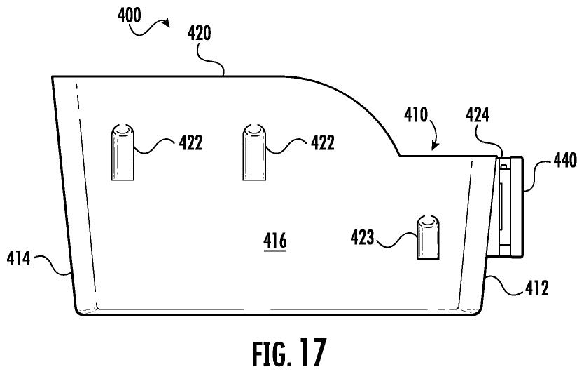

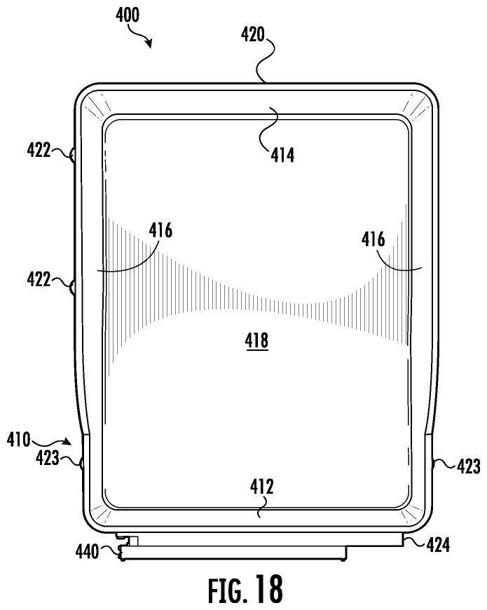

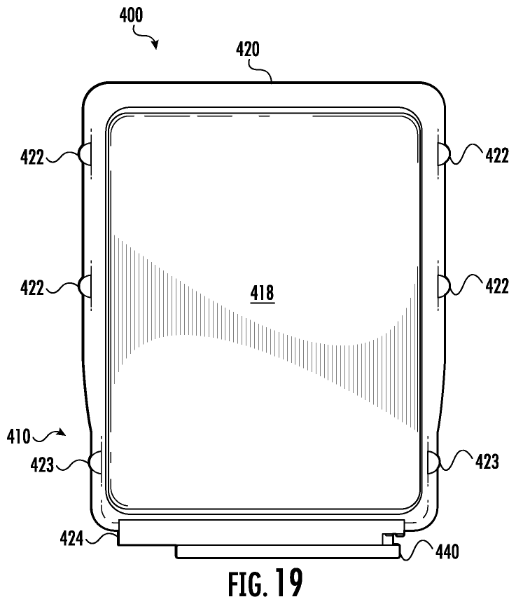

FIG. 16, FIG. 17, FIG. 18, and FIG. 19 show a front view, a side view, a top view, and a bottom view, respectively, of the lab pan 400 shown in FIG. 14.

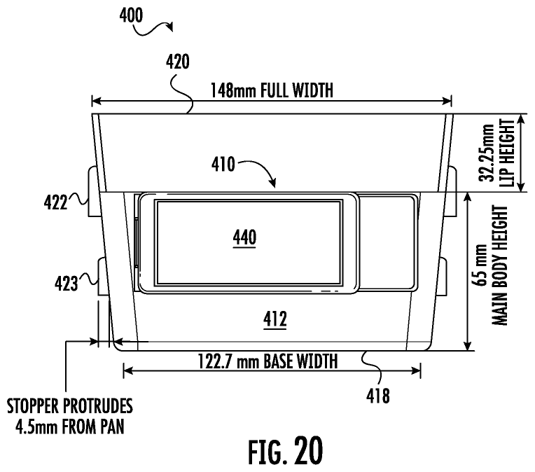

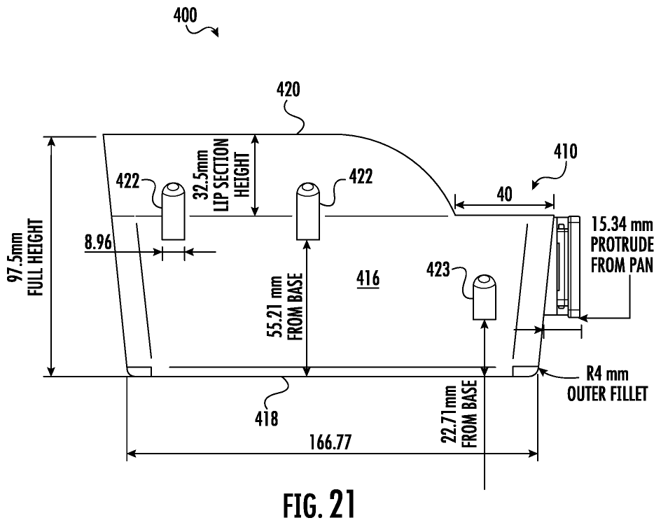

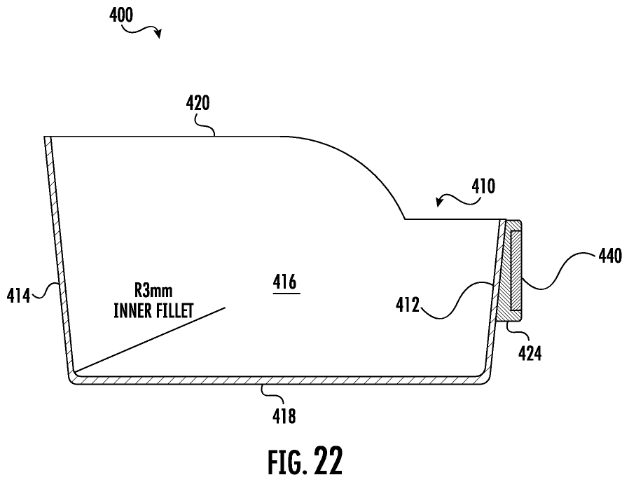

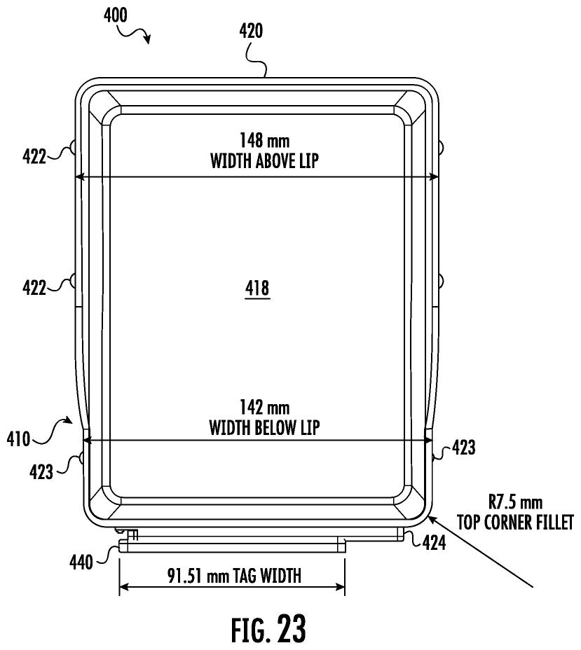

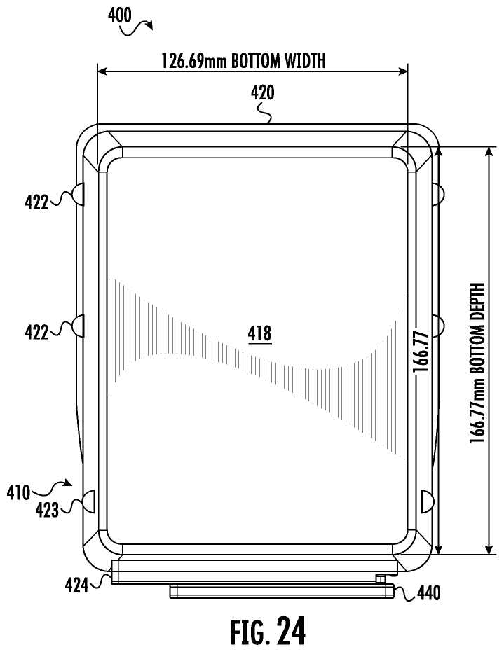

FIG. 20, FIG. 21, FIG. 22, FIG. 23, and FIG. 24 show a front view, a side view, a cross-sectional view (taken front to back), a top view, and a bottom view, respectively, of the lab pan 400 shown in FIG. 14. By way of example, FIG. 20, FIG. 21, FIG. 22, FIG. 23, and FIG. 24 indicate non-limiting example dimensions (in millimeters (mm)) of the lab pan 400 shown in FIG. 14. Other dimensions of the lab pan 400 are contemplated and may be greater or less than those shown.

FIG. 16 through FIG. 24 all show the lab pan 400 with the smart tag 440 installed in the tag track 424. In one example, the design of the tag track 424 on the front panel 412 of the main body 410 is such that with the smart tag 440 installed, the smart tag 440 may be substantially centered on the front panel 412.

FIG. 25, FIG. 26, and FIG. 27 show a perspective view, a front view, and a side view, respectively, of multiple lab pans 400 stacked together. In this example, three lab pans 400 stacked together, but any number of the lab pans 400 can be stacked. Here, the purpose of the upper stop features 422 and the lower stop features 423 is depicted. That is, when stacking one lab pan 400 atop another, the upper stop features 422 of the upper lab pan 400 come to rest atop the upper edge of the top lip portion 420 of the lower lab pan 400. Similarly, the lower stop features 423 of the upper lab pan 400 come to rest atop the upper edge of the main body 410 of the lower lab pan 400.

Multiple lab pans 400 may be easily stackable due to the carefully placed upper stop features 422 and lower stop features 423 on the outer walls. The upper stop features 422 and lower stop features 423 prevent stacked pans from colliding with or damaging the smart tags 440 belonging to neighboring lab pans 400. Enabling each lab pan 400 to safely sit above each smart tag 440, keeping them intact and maximizing readability. More specifically, the placement of the upper stop features 422 and lower stop features 423 causes each pan to stack into each other at a very specific height. In one non-limiting example, the upper stop features 422 and lower stop features 423 are positioned such that the smart tags 440 of each lab pan 400 may sit about 1.5 mm above each other.

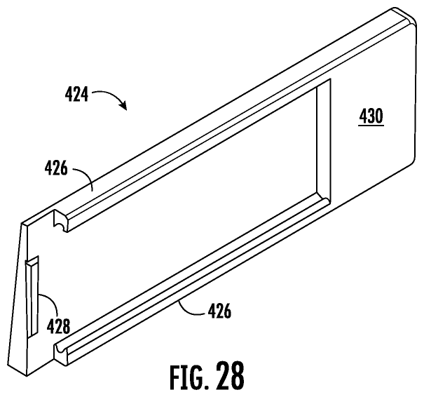

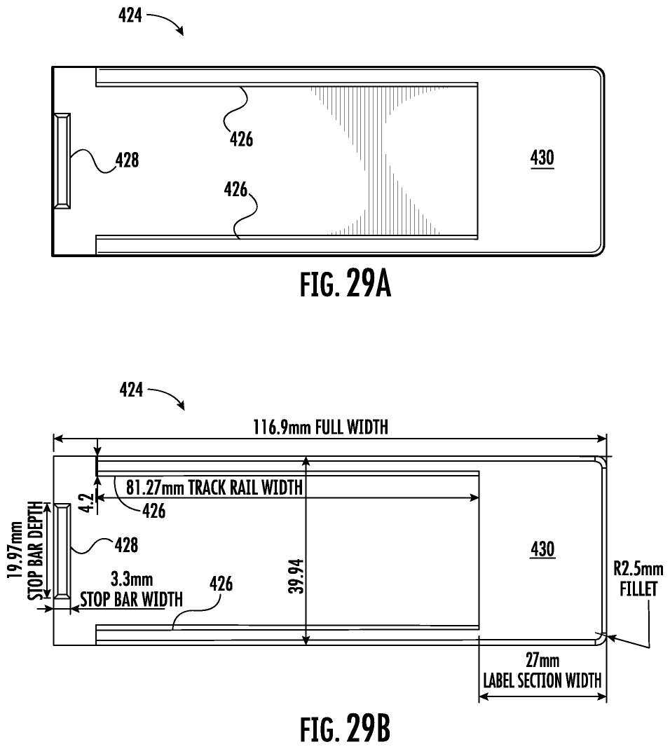

Referring now to FIG. 28 through FIG. 29B is various views of an example of the tag track 424 of the lab pan 400 shown in FIG. 14 through FIG. 27, in accordance with an embodiment of the invention.

FIG. 28 shows a perspective view of the tag track 424 only of the lab pan 400. Again, the tag track 424 may include the pair of track rails 426, the tag lock bar 428, and the track label area 430, all arranged as shown. The track rails 426 and the tag lock bar 428 are provided for engaging with and holding the tag track 424. The tag track 424 with the track rails 426 is designed to slide and lock the smart tag 440 onto the lab pan 400.

FIG. 29A and FIG. 29B show front views of the tag track 424 of the lab pan 400. FIG. 29B indicates non-limiting example dimensions (in millimeters (mm)) of the tag track 424.

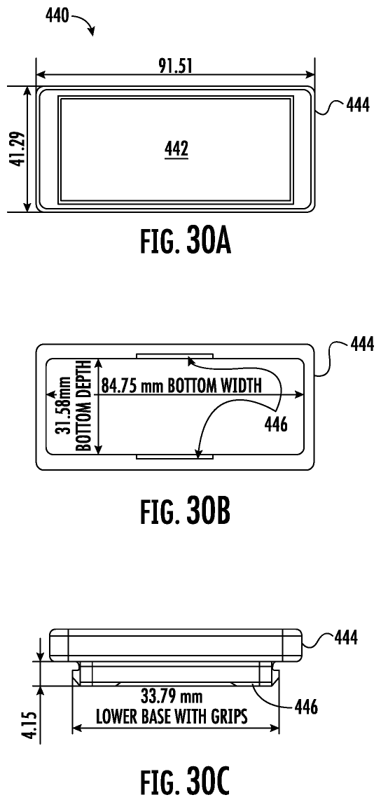

Referring now to FIG. 30A through FIG. 32B is various views of an example of the tag track 424 of the lab pan 400 shown in FIG. 14 through FIG. 27, in accordance with an embodiment of the invention.

FIG. 30A, FIG. 30B, and FIG. 30C show a front view, a back view, and a side view, respectively, of an example of the smart tag 440 of the lab pan 400. Again, the smart tag 440 may include the tag display 442, the display frame 444, and the tag grip portion 446 for fitting into the track rails 426 of the tag track 424. FIG. 30A, FIG. 30B, and FIG. 30C indicate non-limiting example dimensions (in millimeters (mm)) of the smart tag 440.

In one example, the smart tag 440 may be a multifunctional small E-ink low power display device. The tag display 442 of the smart tag 440 may be a customizable display screen that can be programmed and updated freely to display any types of information.

FIG. 31 is a perspective view showing an example action of sliding the smart tag 440 into the tag track 424 of the lab pan 400. The track rails 426 of the tag track 424 are specifically designed to tightly grab the tag grip portion 446 of the smart tag 440. The tag lock bar 428 of the tag track 424 prevents an installed smart tag 440 from easily being removed. Meaning each smart tag 440 may be permanently or semi-permanently associated with a certain individual lab pan 400. The track label area 430 of the tag track 424 may be about a 1-inch-wide flat section that allows additional labels, notes, QR codes, and the like to be attached to each individual lab pan 400.

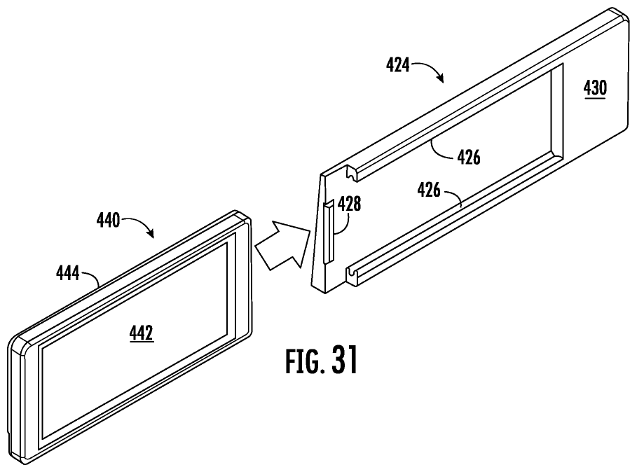

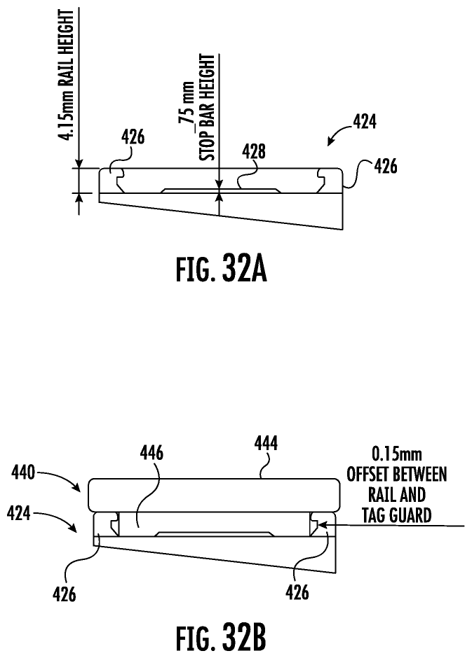

FIG. 32A is an end view showing the tag track 424 of the lab pan 400 without the smart tag 440 installed. FIG. 32B is an end view showing the tag track 424 of the lab pan 400 with the smart tag 440 installed. FIG. 32A and FIG. 32B indicate certain non-limiting dimensions (in millimeters (mm)) of the tag track 424 and the smart tag 440.

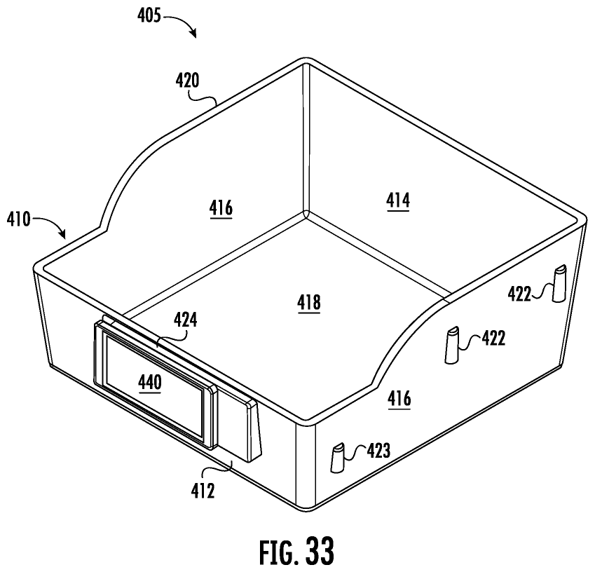

Referring now to FIG. 33 through FIG. 46 is various views of a lab pan 405, which is yet another example of the lab pan 230 of the batch production tracking system 200 shown in FIG. 7, in accordance with an embodiment of the invention.

The lab pan 405 may be substantially the same as the lab pan 400 described above in FIG. 14 through FIG. 27 except for its size. More specifically, the lab pan 405 may be larger than the lap pan 400.

FIG. 33 shows a perspective view of the lab pan 405. Like the lab pan 400, the lab pan 405 may include the main body 410 and the top lip portion 420 on the upper edge of the main body 410. The main body 410 may include the front panel 412, the back panel 414, two side panels 416, and the floor panel 418, all arranged as shown in FIG. 33. Likewise, the lab pan 405 includes an arrangement of upper stop features 422 and lower stop features 423. Likewise, the tag track 424 is provided on the outside of the front panel 412 for receiving and holding the smart tag 440. Generally, the lab pan 405 may be formed of any rigid, lightweight, durable, and cleanable material, such as, but not limited to, molded plastic, aluminum, and/or the like.

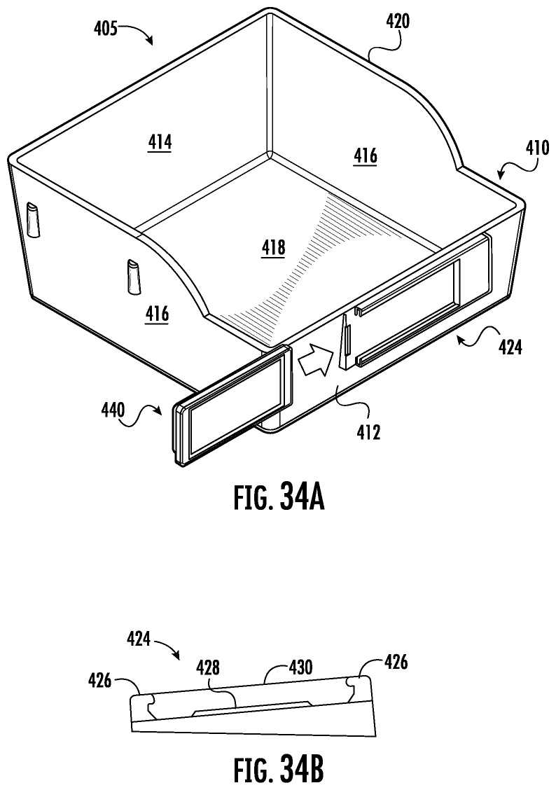

FIG. 34A is another perspective view showing the action of sliding the smart tag 440 into the tag track 424 of the lab pan 405. Like the lab pan 400, with the smart tag 440 installed, the smart tag 440 is substantially centered on the front panel 412 of the lab pan 405. FIG. 34B is an end view showing the tag track 424 of the lab pan 405 without the smart tag 440 installed.

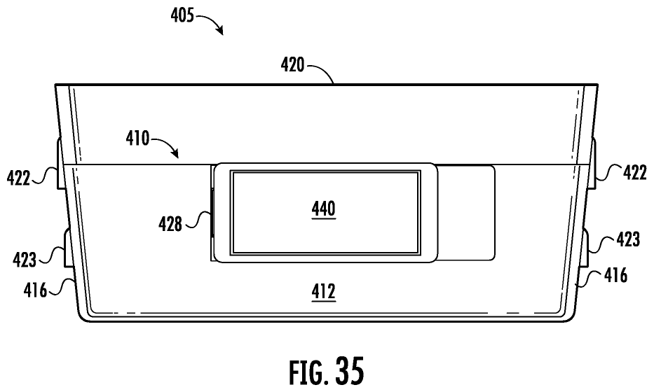

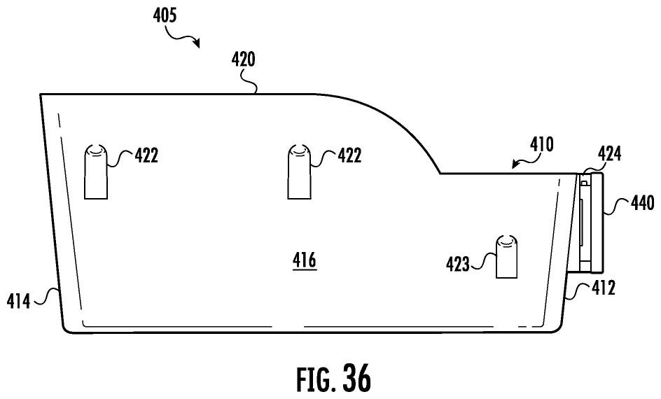

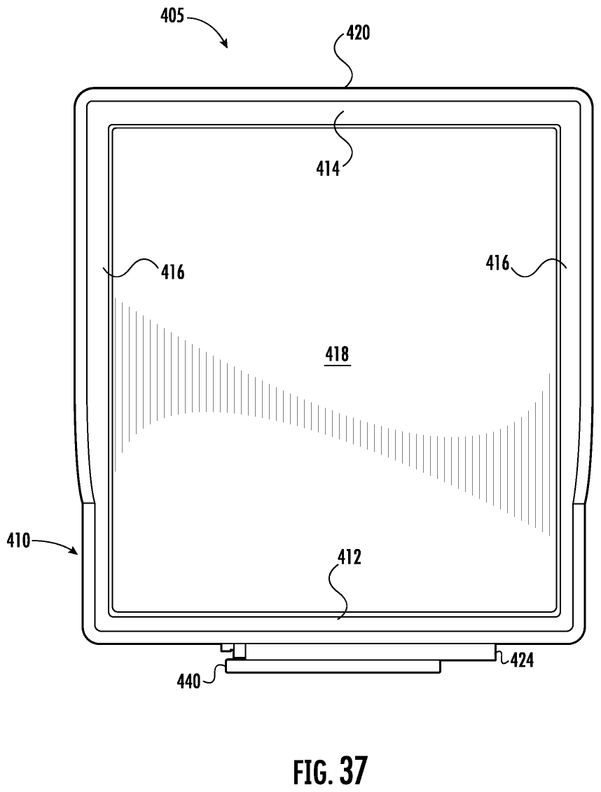

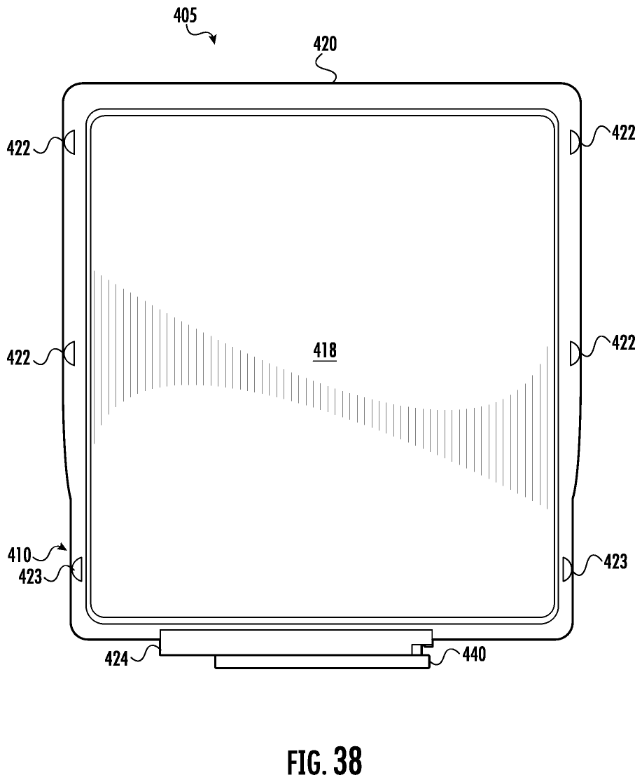

FIG. 35, FIG. 36, FIG. 37, and FIG. 38 show a front view, a side view, a top view, and a bottom view, respectively, of the lab pan 405 shown in FIG. 33.

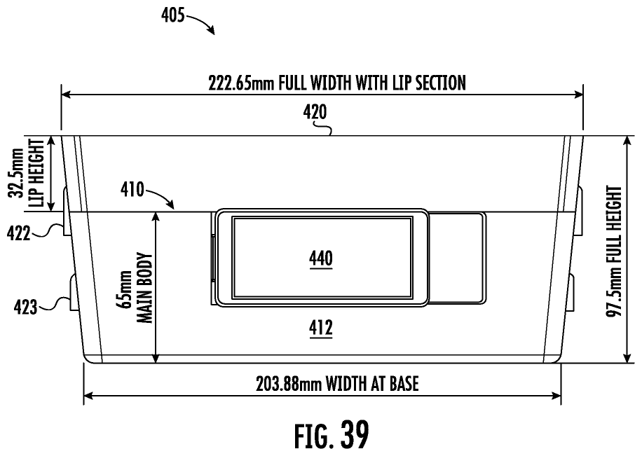

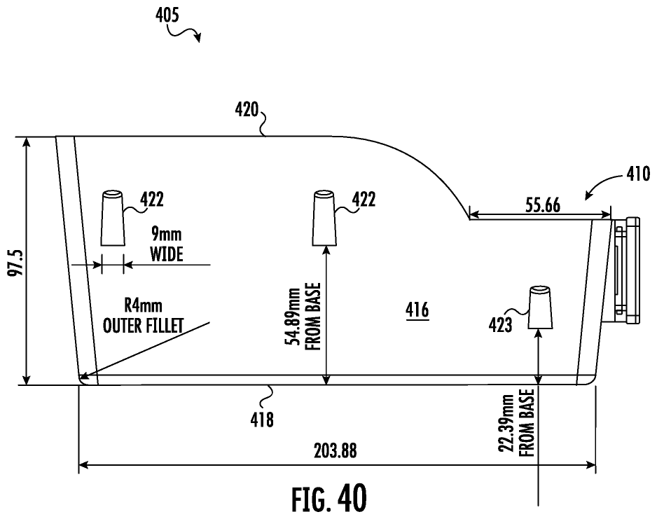

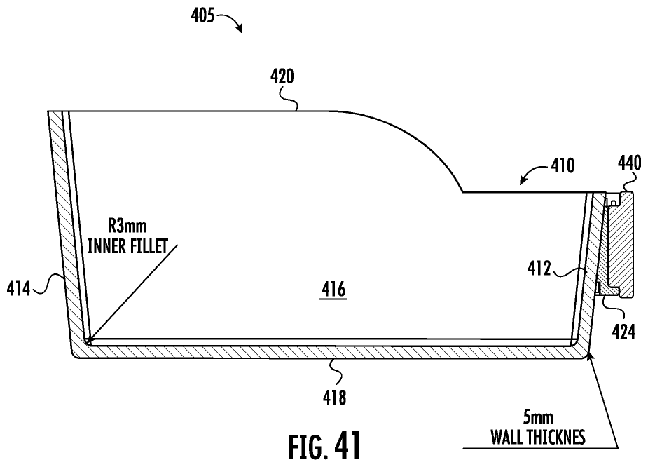

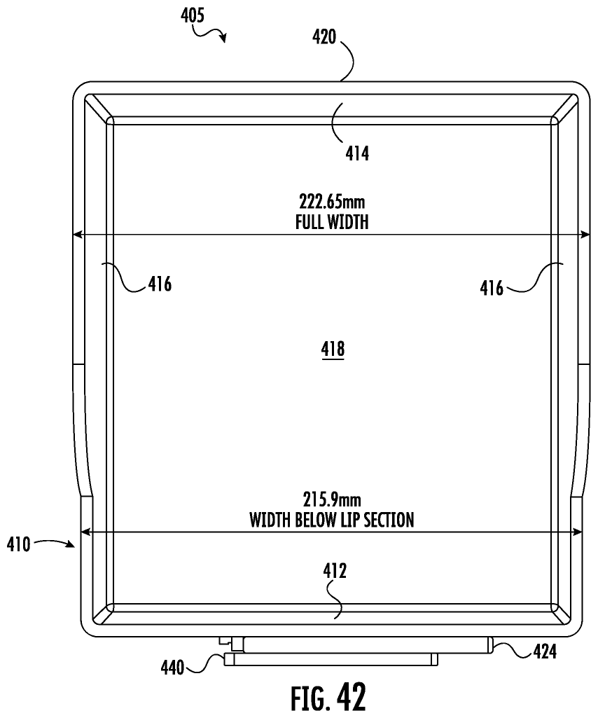

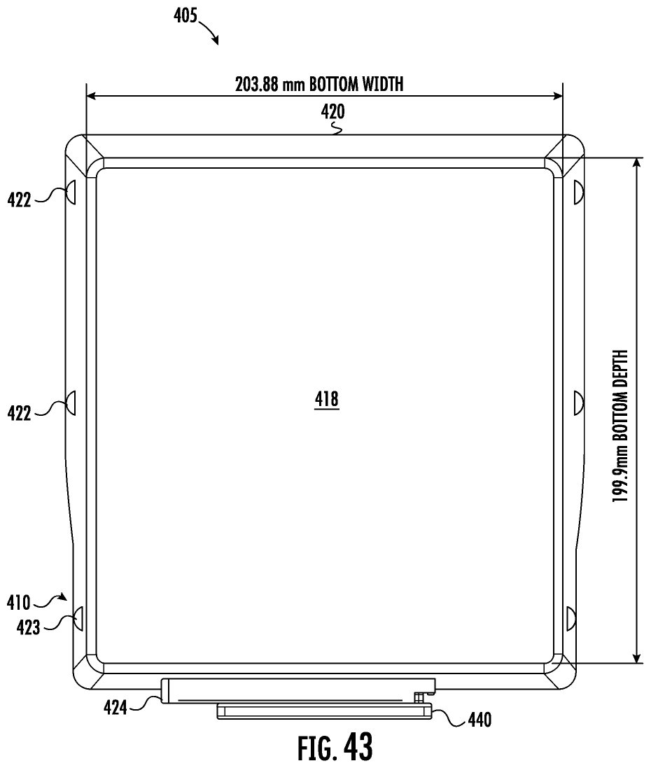

FIG. 39, FIG. 40, FIG. 41, FIG. 42, and FIG. 43 show a front view, a side view, a cross-sectional view (taken front to back), a top view, and a bottom view, respectively, of the lab pan 405 shown in FIG. 33. More specifically, FIG. 39, FIG. 40, FIG. 41, FIG. 42, and FIG. 43 indicate non-limiting example dimensions (in millimeters (mm)) of the lab pan 405 shown in FIG. 33. Other dimensions of the lab pan 400 are contemplated and may be greater or less than those shown.

FIG. 33 through FIG. 43 show the lab pan 405 with the smart tag 440 installed in the tag track 424. The tag track 424 may be positioned on the front panel 412 of the main body 410, such that when installed the smart tag 440 may be substantially centered on the front panel 412 of the lab pan 405.

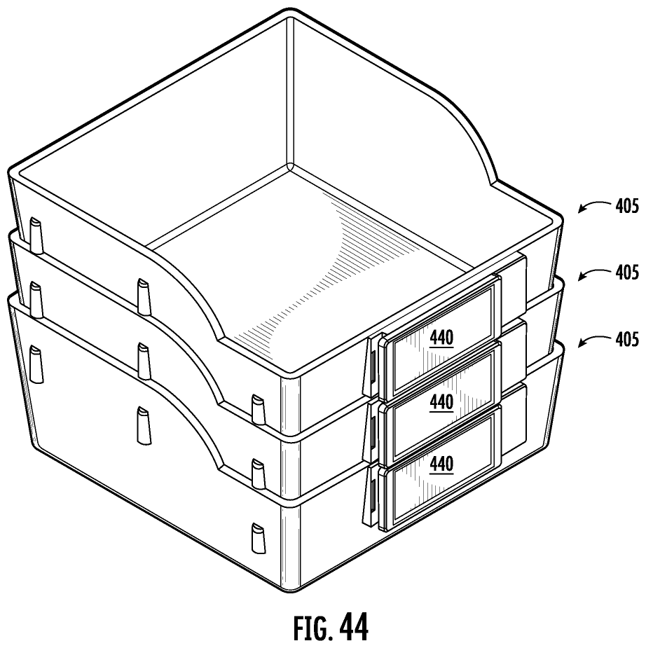

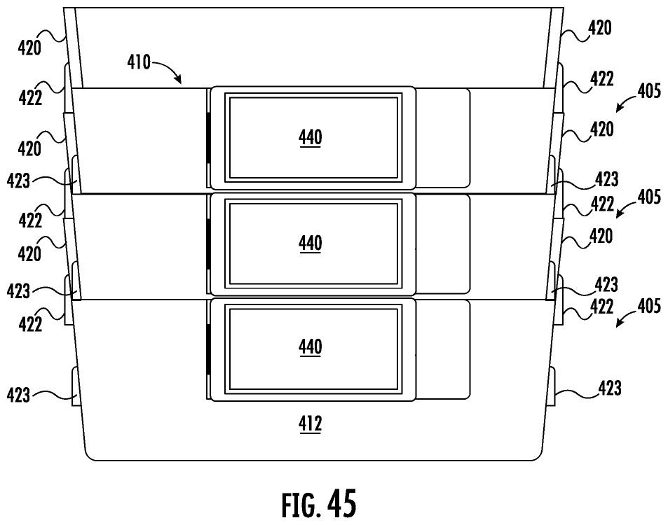

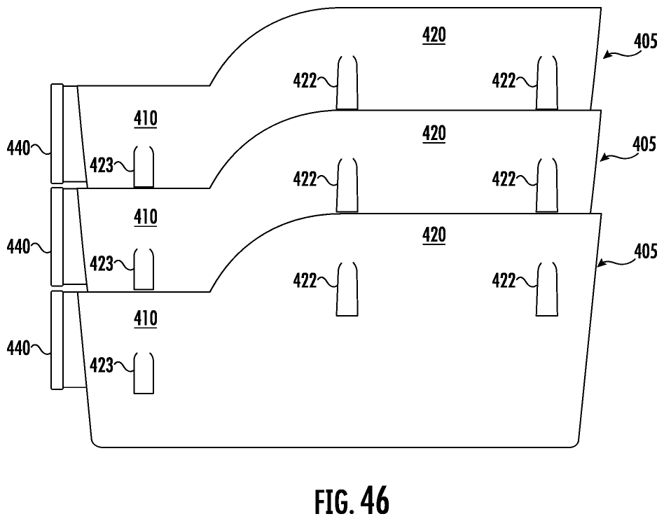

FIG. 44, FIG. 45, and FIG. 46 show a perspective view, a front view, and a side view, respectively, of multiple lab pans 405 stacked together. In this example, three lab pans 405 stacked together, but any number of the lab pans 405 can be stacked. Here, the purpose of the upper stop features 422 and the lower stop features 423 is depicted. That is, when stacking one lab pan 405 atop another, the upper stop features 422 of the upper lab pan 405 come to rest atop the upper edge of the top lip portion 420 of the lower lab pan 405. Similarly, the lower stop features 423 of the upper lab pan 405 come to rest atop the upper edge of the main body 410 of the lower lab pan 405.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A batch production tracking system, comprising:
a. one or more transmitters, wherein each one of the one or more transmitters is associated with a carrier; and
b. an arrangement of one or more sensors, wherein the arrangement of one or more sensors is provided in relation to an arrangement of one or more workstations of a batch production workflow, and wherein the one or more sensors are configured to sense a signal from the one or more transmitters and to determine a location of its associated carrier in the batch production workflow.

2. The system of claim 1, wherein the one or more workstations each comprise an interactive interface, wherein the interactive interface is configured to allow a user to interact with and/or view an operation and/or status of one or more workstations and/or carriers.

3. The system of claim 2, wherein the interactive interface comprises an interactive display device.

4. The system of claim 3, wherein the interactive display device is configured to visually indicate a status of one or more of the carriers and/or the batch production workflow.

5. The system of claim 1, wherein the one or more workstations are arranged in chronological order of steps of the batch production workflow of a product being processed.

6. The system of claim 1, wherein the one or more sensors are configured to measure any one or more of acceleration, location, motion, proximity, light, orientation, force, angular velocity, magnetic field, pressure, altitude, humidity, and/or temperature.

7. The system of claim 1, wherein the one or more sensors comprise short-range wireless low energy sensors.

8. The system of claim 1, wherein the arrangement of the one or more sensors is configured such that sensing ranges of one or more of the one or more sensors overlap.

9. The system of claim 1, wherein each one of the one or more transmitters is physically coupled to a carrier.

10. The system of claim 1, wherein each of the one or more transmitters include a display.

11. The system of claim 1, wherein each carrier used in a particular batch production workflow is linked in the batch production tracking system via its associated transmitter with that specific batch production workflow.

12. The system of claim 3, wherein status and/or case information related to the carrier in the batch production workflow is automatically displayed on the interactive display device of its associated workstation upon the carrier with associated transmitter entering a sensor field of a sensor of the one or more sensors associated with that workstation.

13. The system of claim 1, wherein the one or more transmitters comprise a smart tag.

14. The system of claim 13, wherein the smart tag is configured to attach to the carrier.

15. The system of claim 13, wherein the smart tag includes a display.

16. A carrier, comprising:
a. a main body portion, including a front panel, a back panel, two side panels, and a floor panel;
b. a top lip portion, wherein the top lip portion extends upward from a top edge of the two side panels and the back panel, and wherein the top lip portion forms a wall extending from a point on one of the two side panels to a point on the other of the two side panels, the wall not extending the full length of either of the two side panels;
c. one or more stop features formed on an outer surface of the main body portion and/or the top lip portion; and
d. a transmitter attachment point formed on the main body portion.

17. The carrier of claim 16, wherein the one or more stop features comprise one or more upper stop features and one or more lower stop features formed on each of the two side panels.

18. The carrier of claim 17, wherein the upper stop features and the lower stop features are configured such that when the product carrier is nested within another product carrier a bottom edge of the upper stop features rest atop an upper edge of the top lip portion of the other product carrier and a bottom edge of the lower stop features rest atop an upper edge of the side panels of the other product carrier.

19. The carrier of claim 16, wherein the transmitter attachment point comprises a receiving mechanism configured to receive a transmitter and secure it thereto.

20. The carrier of claim 16, wherein the transmitter comprises a smart tag.

21. The carrier of claim 20, wherein the transmitter attachment point comprises track rails and a locking mechanism, wherein the track rails are configured to receive an upper portion and a lower portion of the smart tag and the locking mechanism is configure to secure the smart tag in place once installed in the track rails.

22. A method of using a batch production tracking system, the method comprising:
a. setting up a batch production workflow for a product to be produced;
b. assigning one or more transmitters to the batch production workflow for the product to be processed, and associating each of the one or more transmitters with a carrier;
c. loading the carrier with items related to producing the product;
d. initiating the batch production workflow;
e. moving the carrier through a series of workstations of the batch production tracking system, wherein the batch production tracking system further comprises an arrangement of sensors associated with one or more of the workstations; and
f. tracking the carrier through the batch production workflow, wherein when the carrier is in a sensing field of one or more of the sensors data from the transmitter associated with that carrier is sensed by the one or more sensors and communicated to an associated one or more workstations.

23. The method of claim 22, wherein setting up a batch production workflow for a product to be produced comprises inputting details of the batch production workflow into a workflow application of the batch production tracking system.

24. The method of claim 22, wherein the data from the transmitter includes information related to the status and/or location of the product carrier in the batch production workflow and/or status and/or operational data of the product being produced.

25. The method of claim 22, wherein the workstations comprise an interactive display and some or all of the sensed data may be displayed thereon.

26. The method of claim 22, wherein data sensed at one workstation is communicated to one or more other workstations.
